(19) United States
(12) Patent Application Publication
(10) Pub. No.: US 2004/0086186 A1
(43) Pub. Date: May 6, 2004

(54) Information providing system and method, information supplying apparatus and method, recording medium, and program

(76) Inventors: Hiroshi Kyusojin, Kanagawa (JP); Kenji Yamane, Tokyo (JP)

Correspondence Address: William E. Vaughan, Bell, Boyd & Lloyd LLC, P.O. Box 1135, Chicago, IL, 60690, US

(21) Appl. No.: 10/634,460

(22) Filed: Aug. 5, 2003

(30) Foreign Application Priority Data
Aug. 9, 2002 (JP) JP2002-233278

(51) Int. Cl. G06K 9/36

(52) U.S. Cl. 382/232

(57) ABSTRACT

An information supplying apparatus that supplies image data of omnidirectional images to at least one information processing apparatus over a network includes, a receiver for receiving viewpoint information from the at least one information processing apparatus. An encoder is provided for encoding the image data of the omnidirectional images, based on the viewpoint information received by the receiving means, such that image data of images in a second direction has a lower resolution than image data of an image in a first direction corresponding to the viewpoint information. The first direction and the second direction are different from each other. A transmitter transmits the image data of the omnidirectional images which is encoded by the encoding means to the at least one information processing apparatus.

The present invention generally relates to information providing systems and methods, information supplying apparatuses and methods, recording media, and programs, and, more particularly, relates to an information providing system and a method, an information supplying apparatus and a method, a recording medium, and a program which reduce the amount of data and which offer real-time distribution.

### BACKGROUND OF THE INVENTION

To allow a user to view “omnidirectional images” in which images in a full 360-degree range are captured with an arbitrary position being as the center, when a plurality (n) of cameras are used to capture the omnidirectional images, the user selects one image out of n images. Thus, a vast amount of information, which includes n times as much image data of the image the user actually views, flows through a network between a storage apparatus in which image data of the omnidirectional images is stored and a playback apparatus that plays back the image data of the omnidirectional images. The same thing can hold true for “omni-view images” in which images of a single object are captured from all circumferential directions.

Meanwhile, Japanese Unexamined Patent Application Publication No. 6-124328 proposes a technique that can adapt to free movement of a user's viewpoint. In this technique, based on the user's viewpoint information, image data is compressed together with data used for image taking and is recorded in an image-recording medium, and only necessary image data is read from the image-recording medium. However, in this case, although the image data recorded in the image-recording medium is compressed, an enormous amount of information must be recorded therein, compared to image data actually required.

In addition, Japanese Unexamined Patent Application Publication Nos. 2000-132673 and 2001-8232 propose techniques for reducing the amount of information transmitted between a storage apparatus and a playback apparatus over a network. In these techniques, image data of a captured image is stored in a storage apparatus, and, based on viewpoint information received from the playback apparatus, necessary image data is read out of n pieces of image data and is transmitted to the playback apparatus.

However, in this case, since only necessary image data is transmitted, a not so small amount of time is required until the next viewpoint information is transmitted from the playback apparatus to the storage apparatus because of response delay in a network. As a result, there are some problems. For example, image switching is delayed and thus prompt switching cannot be performed for a user's sudden request of viewpoint movement, or images are temporarily interrupted.

### SUMMARY OF THE INVENTION

The present invention has been made in view of such situations, and an object thereof is to reduce the amount of information over a network and to provide an image that allows for smooth viewpoint movement.

An information providing system of the present invention includes an information processing apparatus and an information supplying apparatus for supplying image data of omnidirectional images to the information processing apparatus over a network. The information supplying apparatus obtains viewpoint information set by the information processing apparatus. Based on the obtained viewpoint information, the information supplying apparatus encodes the image data of the omnidirectional images such that image data of an image in a second direction has a lower resolution than image data of an image in a first direction corresponding to the viewpoint information, the first direction and the second direction being different from each other, and transmits the encoded image data of the omnidirectional images to the information processing apparatus. The information processing apparatus decodes, out of the received image data of the omnidirectional images, image data corresponding to the viewpoint information, and outputs the decoded image data.

An information providing method of the present invention includes an information supplying method and an information processing method. The information supplying method obtains viewpoint information set by an information processing apparatus. Based on the obtained viewpoint information, the information supplying method encodes the image data of the omnidirectional images such that image data of an image in a second direction has a lower resolution than image data of an image in a first direction corresponding to the viewpoint information, the first direction and the second direction being different from each other and transmits the encoded image data of the omnidirectional images to the information processing apparatus. The information processing method decodes, out of the received image data of the omnidirectional images, image data corresponding to the viewpoint information, and outputs the decoded image data.

An information supplying apparatus of the present invention includes receiving means, encoding means, and transmitting means. The receiving means receives viewpoint information from at least one information processing apparatus. Based on the viewpoint information received by the receiving means, the encoding means encodes the image data of the omnidirectional images such that image data of images in a second direction has a lower resolution than image data of an image in a first direction corresponding to the viewpoint information, the first direction and the second direction being different from each other. The transmitting means transmits the image data of the omnidirectional images which is encoded by the encoding means to the at least one information processing apparatus.

Preferably, the encoding means encodes the image data in a JPEG (Joint Photographic Experts Group) 2000 format. The encoding means may encode the image data of the omnidirectional images, so that, of the images in the second direction, an image in a direction farther from the first direction has an even lower resolution. The resolution may be set by the number of pixels or the number of colors. The information supplying apparatus may further include storing means for storing the image data of the omnidirectional images which is encoded by the encoding means.

The information supplying apparatus may further include combining means for combining the image data of the omnidirectional images which is encoded by the encoding means into one file of image data. The storing means stores the one file of image data combined by the combining means.

The information supplying apparatus may further include converting means for converting, based on the viewpoint information, the resolution of the image data of the images in the second direction, the image data being stored by the storing means, into a lower resolution. The transmitting means transmits the image data of the omnidirectional images which is converted by the converting means.

The information supplying apparatus may further include selecting means for selecting, based on the viewpoint information received by the receiving means from the information processing apparatuses, a highest resolution of the resolutions of the image data of the images in the second direction, the image data being transmitted to the information processing apparatuses. The transmitting means transmits image data of the omnidirectional images which has a resolution lower than or equal to the resolution selected by the selecting means.

An information supplying method of the present invention includes a receiving step, an encoding step, and a transmitting step. The receiving step receives viewpoint information from an information processing apparatus. Based on the viewpoint information received in the receiving step, the encoding step encodes the image data of the omnidirectional images such that image data of an image in a second direction has a lower resolution than image data of an image in a first direction corresponding to the viewpoint information, the first direction and the second direction being different from each other. The transmitting step transmits the image data of the omnidirectional images which is encoded in the encoding step to the information processing apparatus.

A recording medium for an information supplying apparatus according to the present invention records a program that is readable by a computer. The program includes a receiving step, an encoding step, and a transmitting step. The receiving step receives viewpoint information from an information processing apparatus. Based on the viewpoint information received in the receiving step, the encoding step encodes the image data of the omnidirectional images such that image data of an image in a second direction has a lower resolution than image data of an image in a first direction corresponding to the viewpoint information, the first direction and the second direction being different from each other. The transmitting step transmits the image data of the omnidirectional images which is encoded in the encoding step to the information processing apparatus.

A program for an information supplying apparatus according to the present invention is executed by a computer. The program includes a receiving step, an encoding step, and a transmitting step. The receiving step receives viewpoint information from an information processing apparatus. Based on the viewpoint information received in the receiving step, the encoding step encodes the image data of the omnidirectional images such that image data of an image in a second direction has a lower resolution than image data of an image in a first direction corresponding to the viewpoint information, the first direction and the second direction being different from each other. The transmitting step transits the image data of the omnidirectional images which is encoded in the encoding step to the information processing apparatus.

In the information providing system and the method of the present invention, the information supplying apparatus and the method obtain viewpoint information set by the information processing apparatus. Based on the obtained viewpoint information, the information supplying apparatus and the method encode the image data of the omnidirectional images such that image data of an image in a second direction has a lower resolution than image data of an image in a first direction corresponding to the viewpoint information, the first direction and the second direction being different from each other. The information supplying apparatus and the method transmit the encoded image data of the omnidirectional images to the information processing apparatus. The information processing apparatus and the method decode, out of the received image data of the omnidirectional images, image data corresponding to the viewpoint information, and output the decoded image data.

In the information supplying apparatus, the method, the recording medium, and the program, based on the obtained viewpoint information, the image data of the omnidirectional images is encoded such that image data of images in a second direction has a lower resolution than image data of an image in a first direction corresponding to the viewpoint information, the first direction and the second direction being different from each other. The encoded image data of the omnidirectional images is transmitted to the information processing apparatus.

Accordingly, the present invention can provide a system that offers real-time distribution. Also, the present invention can reduce the amount of data over the network. In addition, the present invention can provide a system that is improved in usability.

The network herein refers to a scheme that connects at least two apparatuses and that allows one apparatus to transmit information to another apparatus. The apparatuses that communicate over the network may be independent from each other or may be internal blocks that constitute one apparatus.

Additional features and advantages of the present invention are described in, and will be apparent from, the following Detailed Description of the Invention and the figures.

### BRIEF DESCRIPTION OF THE DRAWINGS

FIG. 1 is a block diagram showing an exemplary configuration of an omnidirectional-image providing system according to the present invention;

FIG. 2 is a view showing the configuration of the external appearance of the image capturing device shown in FIG. 1;

FIG. 3 is a block diagram showing the configuration of the user terminals of the user terminal shown in FIG. 1;

FIG. 4 is a block diagram showing the configuration of the server shown in FIG. 1;

FIG. 5 is a flow chart illustrating communication processing in the omnidirectional image providing system shown in FIG. 1;

FIG. 6 is a view illustrating viewpoint information;

FIG. 7 is a flow chart illustrating the omnidirectional-image image data creating process in step S12 shown in FIG. 12;

FIG. 8 is a view illustrating omnidirectional images;

FIG. 9 is a chart illustrating the flow of data during the omnidirectional-image providing system communication processing shown in FIG. 5;

FIG. 10 is a view illustrating the relationships between viewpoint IDs and camera directions;

FIG. 11 is a view illustrating an encoding method for cameras arranged in vertical directions;

FIG. 12 is a view illustrating an encoding method for cameras arranged in vertical directions;

FIG. 13 is a view illustrating a JPEG 2000 format;

FIG. 14 is a view illustrating a specific example of the JPEG 2000 format;

FIG. 15 is a view illustrating a specific example of the JPEG 2000 format;

FIG. 16 is a view illustrating viewpoint information between images;

FIG. 17 is a view illustrating viewpoint information between images;

FIG. 18 is a view illustrating an encoding method for an image in one direction;

FIG. 19 is a view illustrating an encoding method for the image in one direction;

FIG. 20 is a view illustrating an encoding method for the image in one direction;

FIG. 21 is a view illustrating an encoding method for the image in one direction;

FIG. 22 is a flow chart illustrating the omnidirectional-image image data creating process in step S12 shown in FIG. 5;

FIG. 23 is a flow chart illustrating another example of the communication processing in the omnidirectional image providing system shown in FIG. 5;

FIG. 24 is a flow chart illustrating the omnidirectional-image image-data creating process in step S92 shown in FIG. 23;

FIG. 25 is a flow chart illustrating the omnidirectional-image image-data obtaining process in step S93 shown in FIG. 23;

FIG. 26 is a flow chart illustrating another example of the omnidirectional-image image-data obtaining process in step S93 shown in FIG. 23;

FIG. 27 is a block diagram showing another exemplary configuration of the omnidirectional image providing system according to the present invention;

FIG. 28 is a block diagram showing the configuration of the router shown in FIG. 27;

FIG. 29 is a flow chart illustrating communication processing for the omnidirectional image providing system shown in FIG. 27;

FIG. 30 illustrates a viewpoint table;

FIG. 31 is a flow chart illustrating an image-data transmitting process of the router shown in FIG. 27;

FIG. 32 is a view illustrating omni-view viewpoint information; and

FIG. 33 is a view illustrating omni-view images.

### DETAILED DESCRIPTION OF THE INVENTION

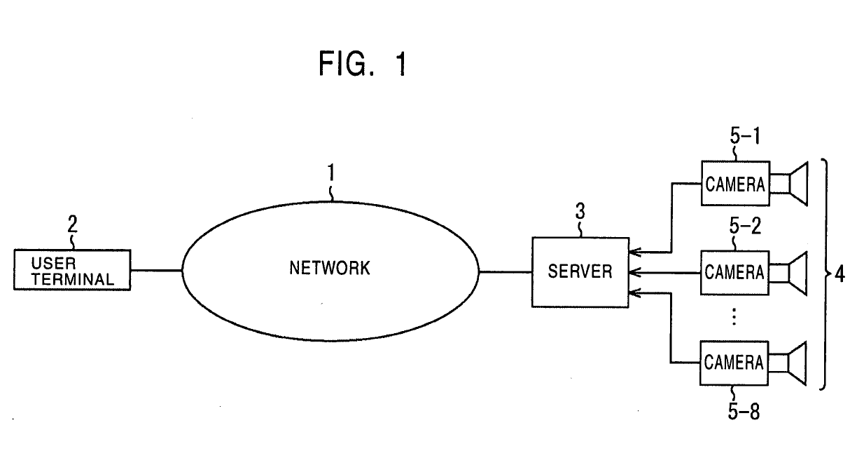

FIG. 1 is a block diagram illustrating an exemplary configuration of an omnidirectional-image providing system according to the present invention. A network 1 may include the Internet, a LAN (local area network), and a WAN (wide area network). A server 3, which supplies image data of omnidirectional images (hereinafter referred to as “omnidirectional-image image data) to user terminals 2, is connected to the network 1. In this example, while only one user terminal 2 and one server 3 are shown, arbitrary numbers of user terminals 2 and servers 3 may be connected to the network 1.

An image capturing device 4, which captures omnidirectional images, is connected to the server 3. The image capturing device 4 is a special camera capable of simultaneously capturing images in a full 360-degree range and includes eight cameras 5-1 to 5-8. The server 3 encodes image data of images captured by the image capturing device 4 and supplies the encoded image data to the user terminal 2 over the network 1. The image data supplied from the server 3 is decoded by the user terminal 2, so that the user can view a desired image of the omnidirectional images.

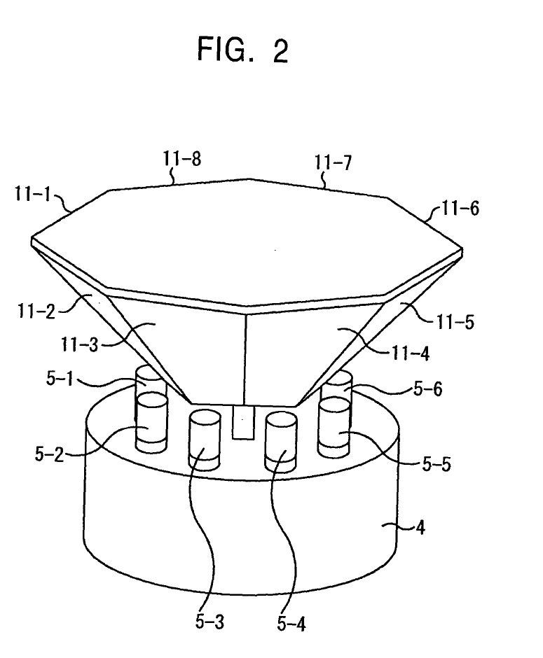

FIG. 2 is a view illustrating the external appearance of the image capturing device 4. The image capturing device 4 is constituted by a camera section and a mirror section. The mirror section includes plane mirrors 11-1 to 11-8, which are attached to the corresponding lateral surfaces of a regular-octagonal pyramid having a regular-octagonal bottom surface. The camera section includes the cameras 5-1 to 5-8, which capture images that are projected on the corresponding plane mirrors 11-1 to 11-8. That is, the eight cameras 5-1 to 5-8 capture images in individual directions, so that images in a full 360 degree range around the image capturing device 4 are captured.

In this omnidirectional-image providing system, the server 3 supplies the omnidirectional images, constituted by eight-directional images captured by the image capturing device 4, to the user terminal 2 over the network 1.

In FIG. 2, although eight plane mirrors and eight cameras are illustrated, any number thereof may be used. Thus, the number that can be used may be less than eight (e.g., six) or more than eight (e.g., ten) as long as the number of plane mirrors and cameras which corresponds to the number of sides of the regular polygon of the mirror section. Thus, the omnidirectional images are constituted by a number of images corresponding to the number of cameras.

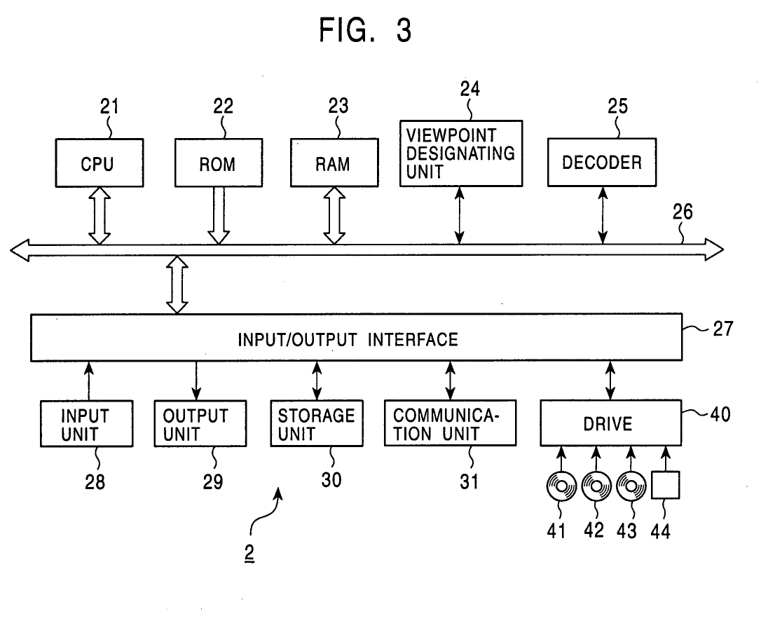

FIG. 3 is a block diagram illustrating the configuration of the user terminal 2. Referring to FIG. 3, a CPU (central processing unit) 21 executes various types of processing in accordance with a program stored in a ROM (read only memory) 22 or a program loaded from a storage unit 30 to a RAM (random access memory) 23. The RAM 23 also stores, for example, data that is needed for the CPU 21 to execute various types of processing, as required.

The CPU 21, the ROM 22, and the RAM 23 are interconnected through a bus 26. A viewpoint designating unit 24, a decoder 25, and an input/output interface 27 are also connected to the bus 26.

The viewpoint designating unit 24 creates viewpoint information from a viewpoint determined based on a user operation of an input section 28. This viewpoint information is output to the decoder 25 and is also transmitted to the server 3 through a communication unit 31 and the network 1.

Based on the viewpoint information created by the viewpoint designating unit 24, the decoder 25 decodes, out of the omnidirectional-image image data transmitted from the server 3 and received by the communication unit 31, image data of an image centering on the viewpoint, and supplies the decoded image data to an output unit 29.

The input unit 28, the output unit 29, the storage unit 30, and the communication unit 31 are also connected to the input/output interface 27. The input unit 28 may include a head-mounted display, mouse, and joystick, and the output unit 29 may include a display, such as a CRT (cathode ray tube) or an LCD (liquid crystal display), and a speaker. The storage unit 30 may include a hard disk, and the communication unit 31 may include a modem or a terminal adapter. The communication unit 31 performs processing for communication over the network 1.

A drive 40 is also connected to the input/output interface 27, as required. For example, a magnetic disk 41, an optical disc 42, a magnetic optical disc 43, and/or a semiconductor memory 44 may be connected to the drive 40, as required, and a computer program read therefrom is installed on the storage unit 30, as required.

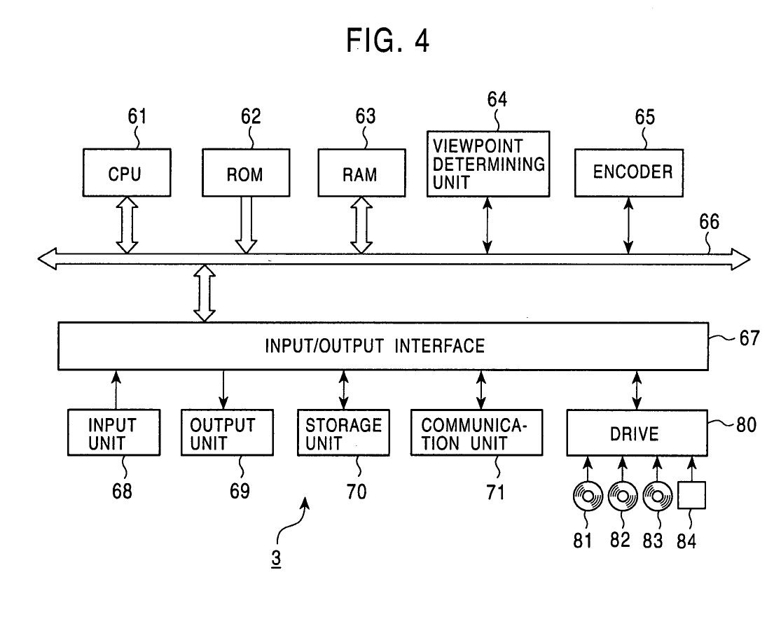

FIG. 4 is a block diagram illustrating the configuration of the server 3. A CPU 61, a ROM 62, a RAM 63, a drive 80, a magnetic disk 81, an optical disc 82, a magnetic optical disc 83, and a semiconductor memory 84 essentially have the same functions as the CPU 21, the ROM 22, the RAM 23, the drive 40, the magnetic disk 41, the optical disc 42, the magnetic optical disc 43, and the semiconductor memory 44 of the user terminal 2 shown in FIG. 3. Thus, the descriptions of those common elements are omitted.

A viewpoint determining unit 64, an encoder 65, and an input/output interface 67 are connected to a bus 66 in the server 3. The viewpoint determining unit 64 determines a viewpoint based on the viewpoint information transmitted from the user terminal 2 over the network 1. Based on the viewpoint information sent from the viewpoint determining unit 64, the encoder 65 encodes image data input from the image capturing device 4, for example, in a JPEG (Joint Photographic Experts Group) 2000 image format, and transmits the encoded image data, as omnidirectional-image image data, to the user terminal 2 through a communication unit 71.

An input unit 68, an output unit 69, a storage unit 70, and the communication unit 71 are connected to the input/output interface 67. The input unit 68 may include a mouse and a keyboard, and the output unit 69 may include a display, such as a CRT (cathode ray tube) or an LCD (liquid crystal display), and a speaker. The storage unit 70 may include a hard disk, and the communication unit 71 may include a modem or a terminal adapter. The communication unit 71 performs processing for communication over the network 1.

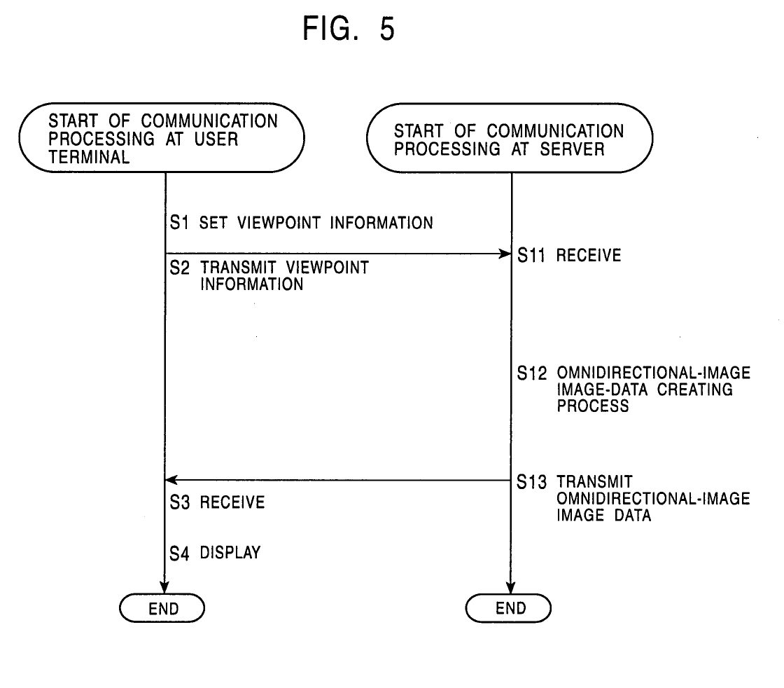

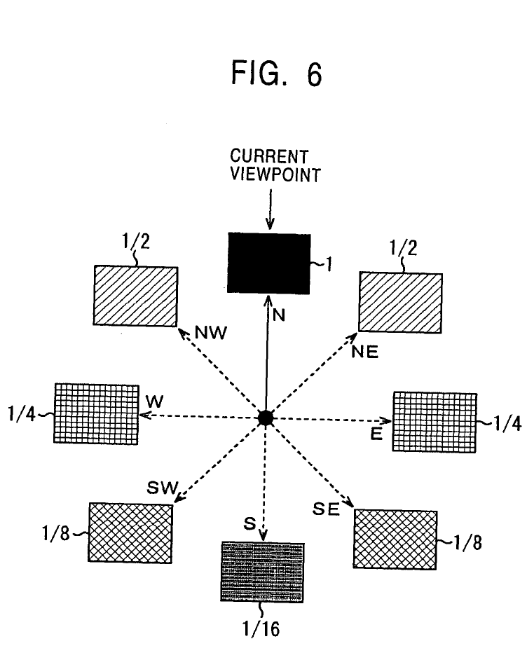

Communication processing in the omnidirectional-image providing system will now be described with reference to the flow chart shown in FIG. 5. In the omnidirectional-image providing system, the omnidirectional images are constituted by eight-directional images that are captured by, for example, eight cameras 5-1 to 5-8, as shown in FIG. 6. Of the eight directions, when the upper center direction is “N” (north), other directions can be expressed by “NE” (north east), “E” (east), “SE” (south east), “S” (south), “SW” (south west), “W” (west), and “NW” (north west) clockwise from “N”. Thus, the lower center direction that is diametrically opposite to “N” is “S”, the rightward direction of “N” is “NE”, and the leftward direction of “N” is “NW”. For convenience of illustration, these eight directions will hereinafter be referred to as “viewpoint information”.

The user operates the input unit 28 of the user terminal 2 to input a current viewpoint (“N” in the present case”). In response to the input, in step S1, the viewpoint designating unit 24 sets viewpoint information representing the current viewpoint. In step S2, the communication unit 31 transmits the viewpoint information (“N” in the present case”) set by the viewpoint designating unit 24 to the server 3 over the network 1.

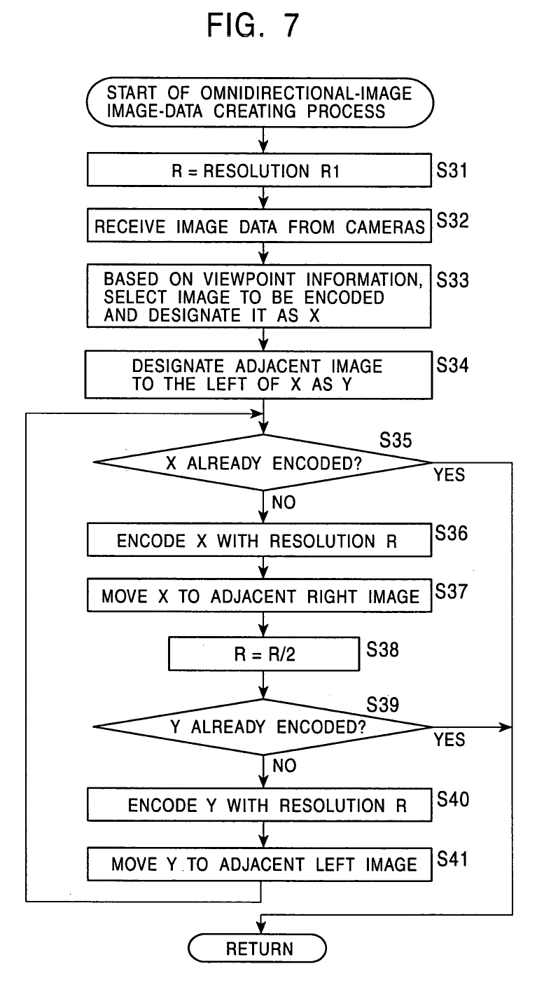

In step S11, the communication unit 71 of the server 3 receives the viewpoint information from the user terminal 2 and outputs the viewpoint information to the viewpoint determining unit 64. In step S12, the encoder 65 executes a process for creating omnidirectional-image image data. This omnidirectional-image image-data creating process will be described with reference to the flow chart shown in FIG. 7.

In step S31, the encoder 65 designates a pre-set resolution (high resolution) R1 as a resolution R. In step S32, the encoder 65 receives the eight-directional image data from the cameras 5-1 to 5-8 of the image capturing device 4.

Based on the viewpoint information from the viewpoint determining unit 64, in step S33, the encoder 65 selects an image in a direction which is to be encoded and designates the selected image as X. In step S34, the encoder 65 designates the adjacent image to the left of X as Y. In the present case, since the current viewpoint information is “N”, X is an “N” image and Y is an “NW” image.

In step S35, the encoder 65 determines whether or not image data of X has already been encoded. When it is determined that image data of X has not yet been encoded, in step S36, the encoder 65 encodes image data of X with the resolution R. That is, image data for “N” is encoded with the pre-set resolution R1. In step S37, the encoder 65 moves X to the adjacent right image. In the present case, X is an “NE” image.

In step S38, the encoder 65 reduces the current resolution (the resolution R1 in the present case) by one half and designates the one-half-resolution as a new resolution R. In step S39, a determination is made as to whether image data of Y has already been encoded. In step S39, when it is determined image data of Y has not yet been encoded, in step S40, the encoder 65 encodes image data of Y with the new resolution R. That is, image data for “NW” is encoded with one-half the resolution R1 (so that the number of pixels is halved).

In step S41, the encoder 65 moves Y to the adjacent left image. In the present case, Y is a “W” image. Thereafter, the process returns to step S35, and the encoder 65 determines whether image data of X has already been encoded. When it is determined that image data of X has not yet been encoded, in step S36, the encoder 35 encodes image data of X with the resolution R. As a result, in the present case, image data for “NE” is encoded with one-half the resolution R1.

In step S37, the encoder 65 moves X to the adjacent right image. In the present case, X is an “NE” image. In step S38, one-half the resolution of the current resolution (i.e., one-half the resolution R1 in the present case) is designated as a new resolution R (i.e., one-fourth the resolution R1). In step S39, the encoder 65 determines whether image data of Y has already been encoded. When it is determined that image data of Y has not yet been encoded, in step S40, the encoder 65 encodes image data of Y with the new resolution R. That is, image data for “W” is encoded with one-fourth the resolution R1.

In step S41, the encoder 65 moves Y to the adjacent left image. In the present case, Y is an “SW” image. Thereafter, the process returns to step S35, and the encoder 65 repeats the subsequent processing. In the same manner, image data for “E” is encoded with one-fourth the resolution R1, image data for “SW” and “SE” is encoded with one-eighth the resolution R1, and image data for “S” is encoded with one-sixteenth the resolution R1.

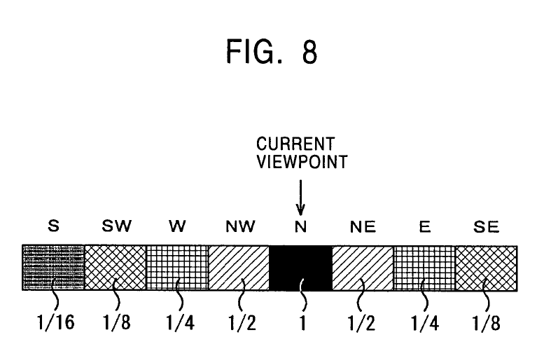

As a result, as shown in FIG. 6 or 8, when the resolution of an image at the current viewpoint “N” is assumed to be 1, the resolutions of “NW” and “NE” images adjacent to the left and right of “N” are ½, the resolutions of a “W” image adjacent to the left of “NW” and an “E” image adjacent to the right of “NE” are ¼, the resolutions of an “SW” image adjacent to the left of “W” and an “SE” image adjacent to the right of “E” are ⅛, and the resolution of an “S” image adjacent to the left of “SW” (i.e., located in the diametrically opposite direction to “N”) is 1/16. In the example of FIG. 8, the images for adjacent directions are arranged with the current viewpoint “N” being as the center.

As described above, image data for a direction that is farther from a current-viewpoint direction and that is predicted as a direction in which the viewer is less likely to move the viewpoint is encoded with a lower resolution than the resolution of image data for a direction closer to the current viewpoint direction.

When it is determined that image data of X has already been encoded in step S35 or when it is determined that image data of Y has already been encoded in S39, image data for all the directions are encoded, and thus the process proceeds to step S13 shown in FIG. 5.

In step S13, the communication unit 71 transmits the omnidirectional-image image data encoded by the encoder 65 to the user terminal 2 over the network 1. In step S3, the communication unit 31 of the user terminal 2 receives the omnidirectional-image image data and supplies it to the decoder 25. In step S4, based on the viewpoint information sent from the viewpoint designating unit 24, the decoder 25 decodes, out of the omnidirectional-image image data, image data for a direction corresponding to the current viewpoint, supplies the decoded image data to the output unit 29, and causes a decoded image to be displayed on a display included in the output unit 29.

As described above, with a viewpoint-information-based viewpoint direction being as the center, image data for other directions are encoded with lower resolutions than the image data for the viewpoint direction. Thus, the amount of information of image data to be transmitted can be reduced, compared to a case in which images in all directions are encoded with the same resolution as an image at the current viewpoint.

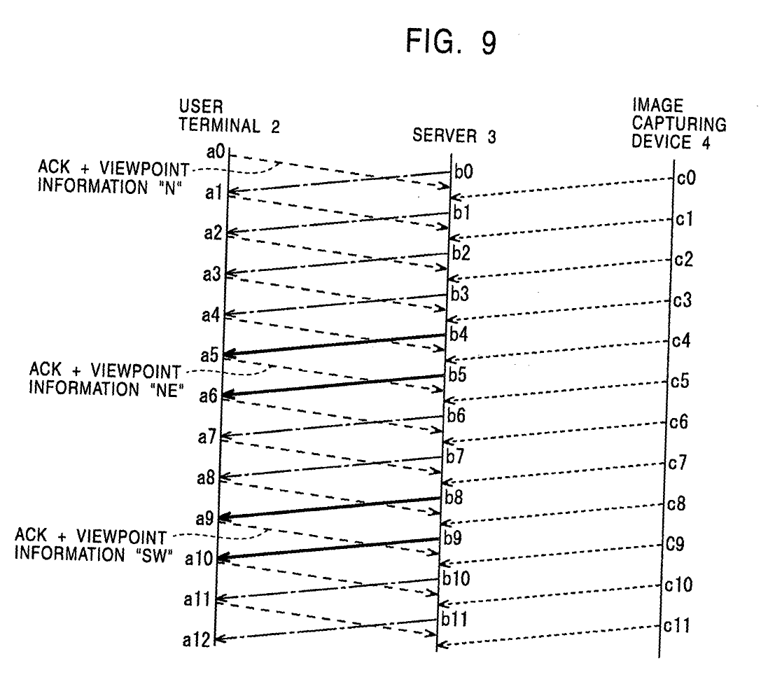

Further, the data flow of the communication processing in the omnidirectional-image providing system shown in FIG. 5 will be described with reference to FIG. 9. In FIG. 9, the vertical direction indicates time axes, and the time elapses from top to bottom. Characters a0, a1, a2, . . . labeled along the time axis for the user terminal 2 indicate timings at which ACKs (acknowledge response packets) and viewpoint information are transmitted from the user terminal 2 to the server 3. Characters b0, b1, b2, . . . labeled along the time axis for the server 3 indicate timings at which packets of image data are transmitted from the server 3 to the user terminal 2. Characters c0, c1, c2, . . . labeled along the time axis for the image capturing device 4 indicate timings at which image data is transmitted from the image capturing device 4 to the server 3.

At timing a0, an ACK and viewpoint information “N” (“N” is the current viewpoint) are transmitted from the user terminal 2. The server 3 receives the viewpoint information “N”, and encodes the image data transmitted from the image capturing device 4 at timing c0, with the viewpoint “N” being as the center. The server 3 then transmits a packet containing the encoded image data to the user terminal 2 at timing b1.

The user terminal 2 receives the packet of the image data immediately before timing a2 and decodes the image data based on the viewpoint information “N”. At timing a2, the user terminal 2 transmits, to the server 3, an ACK, i.e., an acknowledge response packet indicating that the packet of the image data encoded with the viewpoint “N” being as the center” has been received, and the viewpoint information “N”. The above processing is repeated between the user terminal 2 and the server 3 until the user moves the viewpoint.

In this example, after an ACK (an acknowledge response packet indicating the reception of the packet transmitted at timing b3) and viewpoint information “N” are transmitted at timing a4, the user moves the viewpoint from “N” to “NE”, which is adjacent to the right of “N”. In response to the movement, after timing a5, the viewpoint information set at the user terminal 2 is changed from “N” to “NE”.

However, at timings b4 and b5 at which the server 3 transmits packets of image data, since the changed viewpoint information “NE” has not yet been transmitted to the server 3, the server 3 encodes image data, transmitted from the image capturing device 4 at timings c3 and c4, with the viewpoint “N” being as the center, and transmits a packet of the encoded image data to the user terminal 2.

Thus, the user terminal 2 receives the packet of the image data encoded with the viewpoint “N” being as the center, immediately before timings a5 and a6, and decodes the image data based on the changed viewpoint information “NE”. The resolution of the “NE” image is still one-half the resolution of the “N” image, image data for “NE” is decoded with one-half the standard resolution. Thus, the output unit 29 displays an image of the current actual viewpoint “NE” at one-half the standard quality.

After transmitting the packet of the image data at timing b5, the server 3 receives the ACK and the viewpoint information “NE” which are transmitted at timing a5 from the user terminal 2. Thus, after the next timing b6, the server 3 changes encoding so as to encode image data based on the viewpoint information “NE”. As a result, immediately before timing a7, the user terminal 2 receives a packet of image data encoded with the viewpoint “NE” being as the center, and decodes the image data based on the viewpoint information “NE”. Thus, after this point, an image at the current viewpoint “NE” is displayed with the standard resolution.

At timing a7, the user terminal 2 transmits, to the server 3, an ACK, i.e., an acknowledge response packet indicating that the packet of the image data encoded with the viewpoint “NE” being as the center has been received, and viewpoint information “NE”. The above processing is repeated between the user terminal 2 and the server 3 until the user moves the viewpoint.

In this example, after an ACK (an acknowledge response packet indicating the reception of the packet transmitted at timing b7) and viewpoint information “NE” are transmitted at timing a8, the user moves the viewpoint from “NE” to “SW”, which is in the diametrically opposite direction to “NE”. In response to the movement, after timing a9, the viewpoint information that is set at the user terminal 2 is changed from “NE” to “SW”.

However, at timings b8 and b9 at which the server 3 transmits packets of image data, since the changed viewpoint information “SW” has not yet been transmitted to the server 3, the server 3 encodes image data, transmitted from the image capturing device 4 at timings c7 and c8, with the viewpoint “NE” being as the center, and transmits the encoded data to the user terminal 2.

Thus, immediately before timings a9 and a10, the user terminal 2 receives the packets of the image data encoded with the viewpoint “NE” being as the center, and decodes the image data based on the viewpoint information “SW”. The resolution of the “SW” image is still 1/16 relative to the resolution of the “NE” image, and thus the image data of “SW” is decoded with one-sixteenth the standard resolution. Thus, the output unit 29 displays an image of the current actual viewpoint “SW” with one-sixteenth the standard quality.

After transmitting a packet of image data at timing b9, the server 3 receives viewpoint information “SW” that has been transmitted at timing a9 from the user terminal 2. Thus, after timing b10, the server 3 changes encoding so as to encode image data based on the viewpoint information “SW”. As a result, immediately before timing a11, the user terminal 2 receives the packet of the image data encoded with the viewpoint “SW” being as the center and decodes the image data based on the viewpoint information “SW”. Thus, after this point, an image of the current viewpoint “SW” is displayed with the standard resolution.

At timing a11, the user terminal 2 transmits an ACK, i.e., an acknowledge response packet indicating that the packet of the image data encoded with the viewpoint “SW” being as the center has been received, and viewpoint information “SW”. The above processing is repeated between the user terminal 2 and the server 3 until the user moves the viewpoint.

As described above, the user terminal 2 and the server 3 execute the communication processing, so that the movement of the viewpoint at the user terminal 2 can be smoothly processed. That is, even when the viewpoint is changed to one direction in 360 degrees (to one direction of the eight directions), it is possible to promptly display an image of a new viewpoint. Since prompt displaying is possible, an image after the viewpoint is changed is degraded correspondingly. However, the degree of the degradation is stronger as a changed viewpoint is farther from the current viewpoint (i.e., as the possibility that the viewer changes the viewpoint is lower), and the degree of degradation is weaker as a changed viewpoint is closer to the current viewpoint (i.e., as the possibility that the viewer changes the viewpoint is greater). Thus, it is possible to achieve a preferable user interface by which the user is satisfied with changes in image degradation.

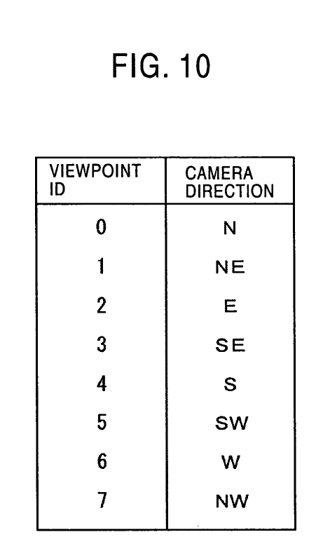

In the above description, the viewpoint information has been illustrated by using “N”, NE”, and the like that represent the directions of the cameras. In practice, however, as shown in FIG. 10, viewpoint identifications (IDs) may be set with respect to the directions of the cameras 5-1 to 5-8 such that the relationships between the set viewpoint IDs and the directions of the cameras 5-1 to 5-8 are shared by the user terminal 2 and the server 3.

In the case of FIG. 10, viewpoint ID “0” corresponds to a camera direction “N”, viewpoint ID “1” corresponds to a camera direction “NE”, viewpoint ID “2” corresponds to a camera direction “E”, viewpoint ID “3” corresponds to a camera direction “SE”, viewpoint ID “4” corresponds to a camera direction “S”, viewpoint ID “5” corresponds to a camera direction “SW”, viewpoint ID “6” corresponds to a camera direction “W”, and viewpoint ID “7” corresponds to a camera direction “NW”. In this example, therefore, these viewpoint IDs are written in the viewpoint information transmitted from the user terminal 2.

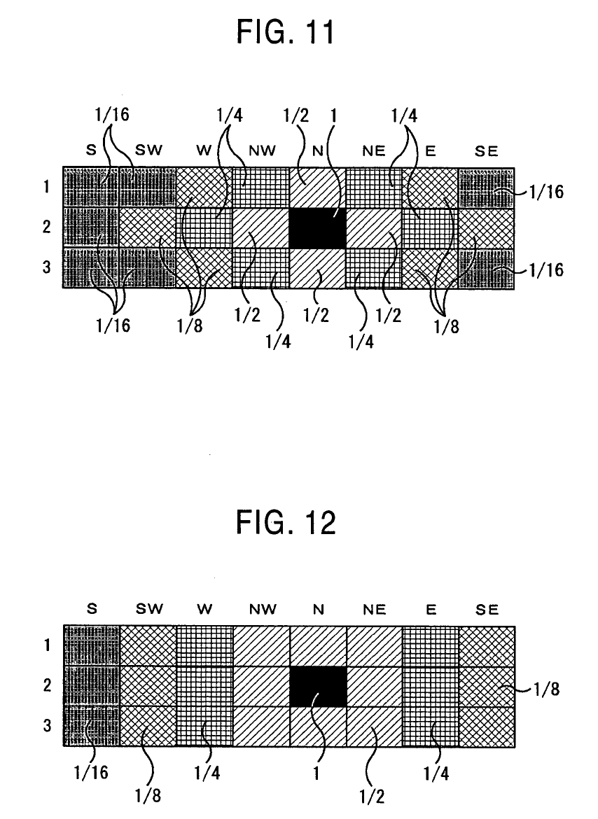

While the above description has been given of the viewpoint movement in the horizontal direction corresponding to the cameras 5-1 to 5-8, a case in which a plurality of cameras are arranged in the vertical direction at the image capturing device 4 is also possible. An example of an image-data encoding method when a plurality of cameras are provided in the vertical direction will now be described with reference to FIGS. 11 and 12. In FIGS. 11 and 12, images for adjacent directions are arranged with a current viewpoint “N2” being as the center, as in the case of FIG. 8. “N” of “N2” indicates a position in the horizontal direction and “2” thereof indicates a position in the vertical direction.

In the case of FIGS. 11 and 12, in addition to the cameras that capture images in eight horizontal directions, i.e., “S”, “SW”, “W”, “NW, “N”, “NE”, “E”, and “SE” from the left, the image capturing device 4 includes cameras that capture images in three vertical directions, i.e., “1”, “2”, and “3” from top. Thus, omnidirectional images in this case are constituted by images in 24 directions.

In the example of FIG. 11, when the resolution of an image at the current viewpoint “N2” is 1, the resolutions of “N1” and “N3” images, which are adjacent to the top and bottom of “N2”, are set to ½, as well as the resolutions of “NW2” and “NE2” images, which are adjacent to the left and right of “N2”. The resolutions of “NW1”, “W2”, “NW3”, “NE1”, “E2”, and “NE3” images, which are adjacent to the images having the one-half resolution, are set to ¼. Further, the resolutions of “SW2”, “W1, “W3”, “E1”, “E3”, and “SE2” images, which are adjacent to the images having the one-fourth resolution, are set to ⅛, and the resolutions of the other “S1”, “S2”, “S3”, “SW1”, “SW3”, “SE1”, and “SE3” images are set to 1/16.

Since the viewpoint can also be moved in the vertical directions, the viewpoint may be moved in oblique directions, in conjunction with the horizontal directions. In such a case, as shown in FIG. 12, an encoding method that allows for movements in oblique directions, such as a movement from “N2” to “NE1” and a movement from “N2” to “NW1” can also be used.

In the example of FIG. 12, when the resolution of an image at the current viewpoint “N2” is 1, the resolutions of “NW1”, “NW2”, “NW3”, “N1”, “N3”, “NE1”, “NE2”, and “NE3” images, which surround “N2”, are set to be ½. The resolutions of “W1”, “W2”, “W3”, ”E1”, “E2”, and “E3” images, which are adjacent to those images having the one-half resolution, are set to ¼. Further, the resolutions of “SW1”, “SW2, “SW3”, “SE1”, “SE2”, and “SE3” images, which are adjacent to the those images having the one-fourth resolution are set to ⅛, and the resolutions of the other “S1”, “S2”, and “S3” images are set to 1/16.

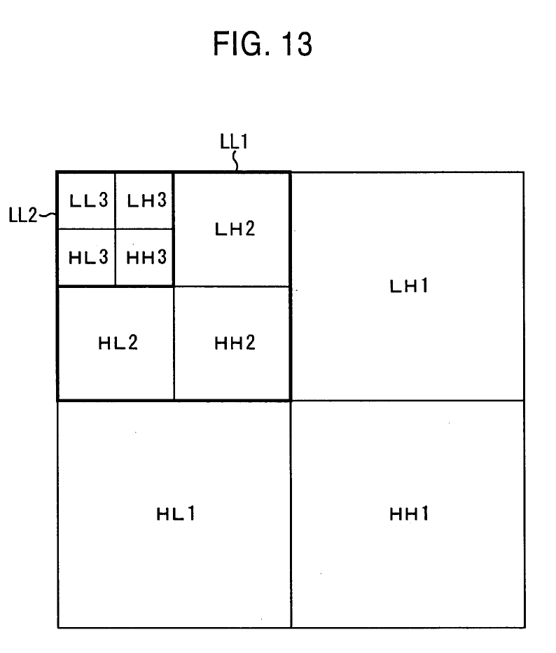

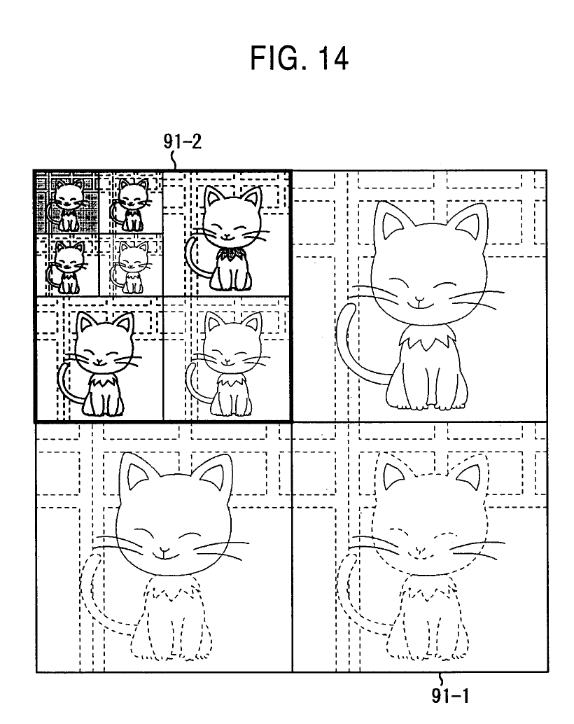

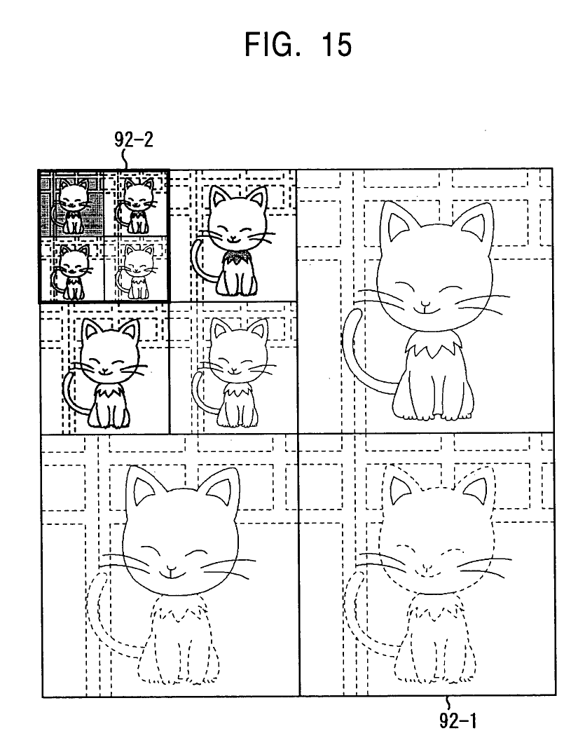

As described above, when a plurality of cameras are also provided in the vertical directions, image data in individual directions is encoded with different resolutions, so that the amount of image data information to be transmitted can be reduced. Next, a JPEG 2000 image format, which is used as a system for encoding images in the omnidirectional-image providing system shown in FIG. 1, will be described with reference to FIGS. 13 to 15. FIG. 13 is a schematic view illustrating an example of wavelet transform in a JPEG 2000 format, and FIGS. 14 and 15 show specific examples of the wavelet transform shown in FIG. 13. In the JPEG 2000 format, after an image is divided into rectangular block regions (cells), wavelet transform can be performed for each divided region.

In the wavelet transform shown in FIG. 13, an octave division method is used. In this method, low-frequency components and high-frequency components in the horizontal and vertical directions are extracted from image data, and, of the extracted components, the most important elements, namely, low-frequency components in the horizontal and vertical directions, are recursively divided (three times in the present case).

In the example of FIG. 13, with respect to “LL”, “LH”, “HL”, and “HH”, the first characters thereof represent horizontal components and the second characters represent vertical components, with “L” indicating low-frequency components and “H” indicating high-frequency components. Thus, in FIG. 13, an image is divided into “LL1”, “LH1”, “HL1”, and “HH1”. Of the images, “LL1”, which are low frequency components in both the horizontal and vertical directions, are further divided into “LL2”, “LH2”, “HL2”, and “HH2”. Of the images, “LL2”, which are low frequency components in both the horizontal and vertical directions are further divided into “LL3”, “LH3”, “HL3”, and “HH3”.

As a result, as shown in FIG. 14, when the resolution of an original image 91-1 is 1, an image 91-2 having one-half the resolution can be extracted without being decoded (i.e., while still being encoded). Also, as shown in FIG. 15, when the resolution of an original image 92-1 is 1, an image 92-2 having one-fourth the resolution can be extracted without being decoded.

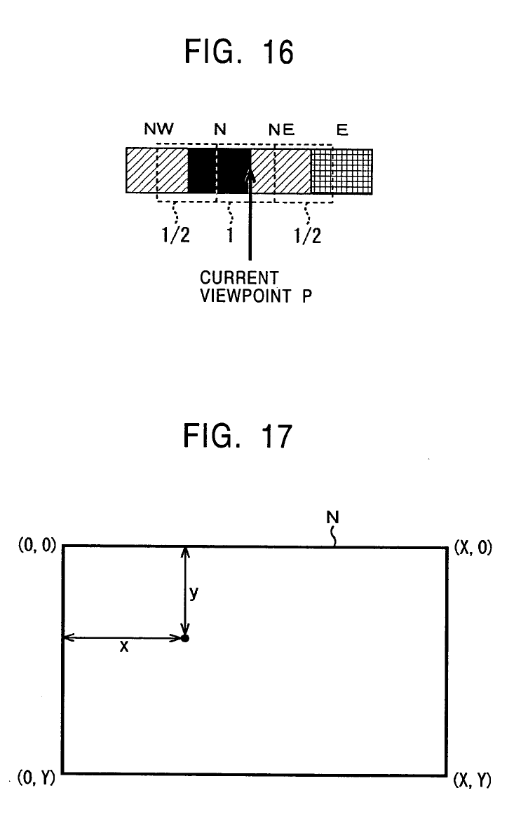

The hierarchical encoding is employed as described above, a decoding side can select the image quality and the size of an image still being encoded, (without decoding it). Further, in the JPEG 2000 format, the resolution of a specific region in one image can be readily changed. For example, in the example of FIG. 16, a current viewpoint P is set at such a center position between “N” and “NE” which involve a plurality of cameras, rather than at a position that involves one camera direction. In this case, with the JPEG 2000 format, the right half of the “N” image and the left half of the “NE” image can be compressed with a resolution of, for example, 1, and the left half of the “N” image, the right half of the “NW” image, the right half of the “NE” image, and the left half of the “E” image can be compressed with one-half the resolution. Thus, a viewpoint movement that is not restricted by each camera direction can be achieved.

As shown in FIG. 17, the “N” image in the example of FIG. 16 can be defined in an X-Y coordinate plane (0≦x≦X, 0≦y≦Y) with the left corner as the origin. The current viewpoint can be determined by an “x coordinate” and a “y coordinate”. Thus, the viewpoint information in the example of FIG. 16 can be created by expression (1) below with the determined current viewpoint the “x coordinate”, the “y coordinate”, and a viewpoint ID (i) that determines a “camera direction”.

{(i, x, y)|i=∈({0, 1, 2, 3, 4, 5, 6, 7}, 0≦x≦X, 0≦y≦Y} (1)

When the viewpoint can be moved only for each camera, the viewpoint is fixed and is expressed by x=X/2 and y=Y/2. For example, the viewpoint information of the viewpoint P shown in FIG. 16 is expressed as (i, x, y)=(0, X, Y/2), since it is located at the center position between “N” and “NE”.

In the example of FIG. 16, although the viewpoint information has been described as being one point on the image, the viewpoint information may be vector information representing “one point and its movement direction”. This allows the server 3 to predict the viewpoint movement.

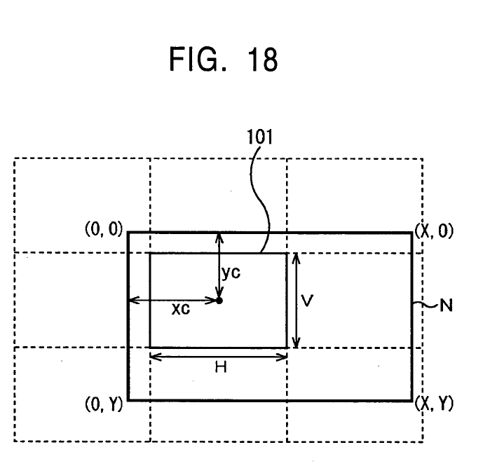

As described above, an image in each direction is encoded using the JPEG 2000 format, thereby allowing viewpoint movements that are not restricted by each camera direction. Although the resolution is set for each image (each screen) output by one camera in the above description, different resolutions can be set for individual regions within one screen (each region represented by hatching in FIGS. 6, 8, 11, and 12 is one image (screen)). An example of such a case will now be described with reference to FIGS. 18 to 20.

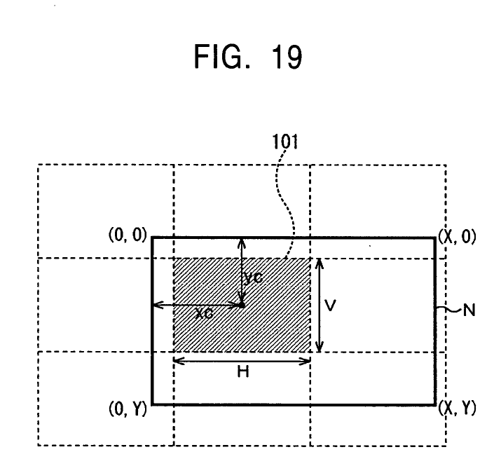

In FIGS. 18 to 20, a region that is surrounded by the thick solid line and that has a horizontal length X and a vertical length Y represents one image (screen) (e.g., an “N” image). In FIG. 18, in X-Y coordinates with the upper left corner as the origin, the “N” image can be expressed by the range of 0≦x≦X and 0≦y≦Y, in the same manner as FIG. 17, and an area 101 therein can be expressed by a region surrounded by a horizontal length H and a vertical length V (X/2≦H, Y/2≦V) with a viewpoint (xc, yc) as the center. In this case, as shown in FIG. 19, data for an area that satisfies xc−H/2≦x≦xc+H/2 and yc−V/2≦y≦yc+V/2 (i.e., an area inside the region 101) of the coordinates (x, y) in the “N” image is encoded with the set resolution R1 (the highest resolution).

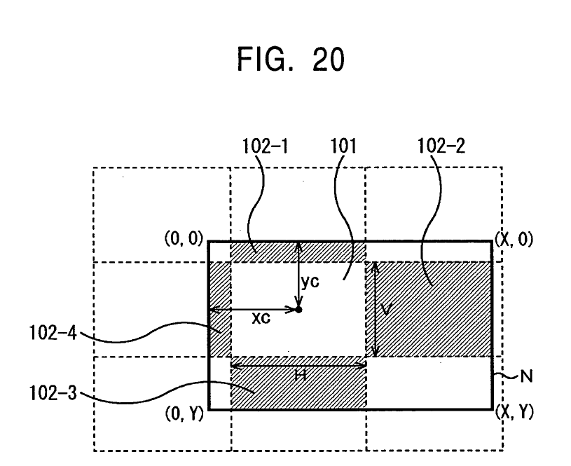

As shown in FIG. 20, of the coordinates (x, y) in the “N” image, data for areas that satisfy xc−H/2≦x≦xc+H/2 or yc−V/2≦y≦yc+V/2 except the area that satisfies xc−H/2≦x≦xc+H/2 and yc−V/2≦y≦yc+V/2 (i.e., areas indicated by regions 102-1 to 102-4 that are adjacent to the top, bottom, left, and right edges of the region 101) is encoded with one-half the resolution R1.

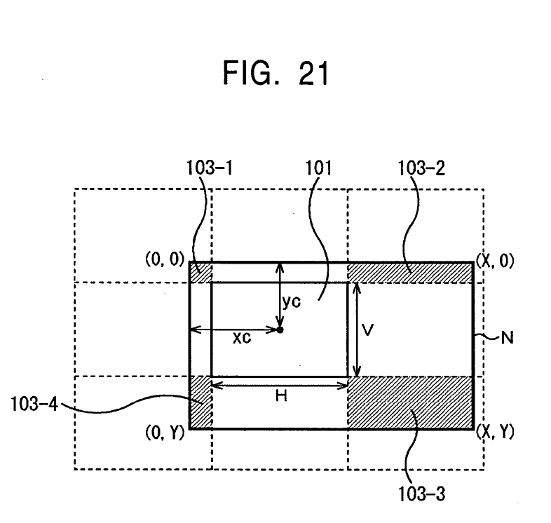

In addition, as shown in FIG. 21, data for areas that neither satisfy xc−H/2≦x≦xc+H/2 nor yc−V/2≦y≦yc+V/2 (i.e., regions 103-1 to 103-4 that are out of contact with the top, bottom, left, and right edges of the region 101 (but are in contact with the area 101 in the diagonal directions)) is encoded with one-fourth the resolution R1.

As described above, the resolutions for individual regions in one image may be changed based on viewpoint information. By doing this, in addition to “a current direction in which the viewer is viewing”, the viewpoint information can be extended up to “portions in an image in that direction the viewer is viewing ” and a specific region within an image (e.g., the current viewpoint “N”) that is compressed with a standard resolution can be compressed with an even higher resolution.

As described above, encoding image data by the use of the JPEG 2000 format makes it possible to encode an arbitrary position in a one-directional image captured by one camera, with a resolution different from a resolution for other positions. While the resolution has been changed by varying the number of pixels depending on regions in the above description, the resolution may be changed by varying the number of colors.

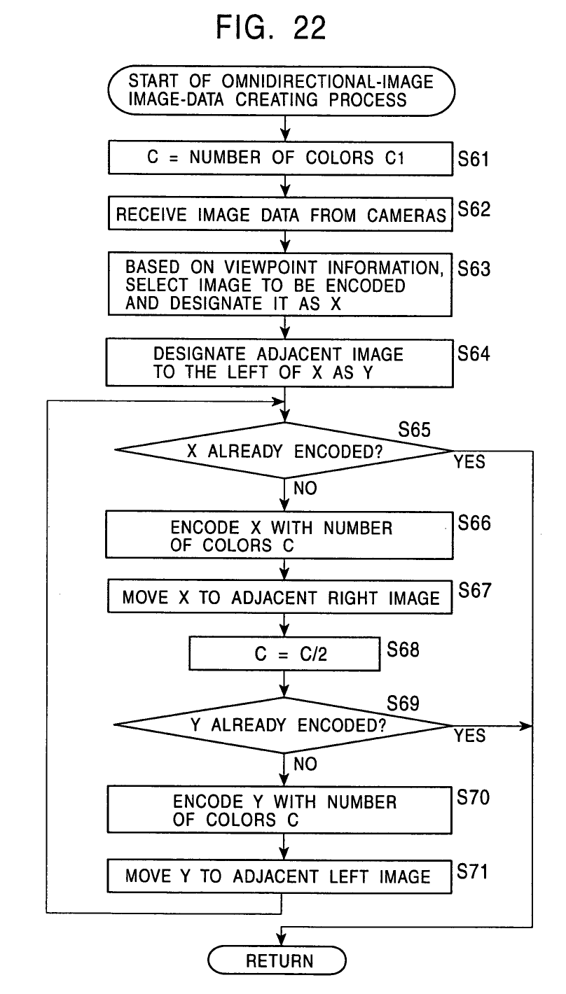

Next, a process for creating omnidirectional-image image data when the resolution is changed by reducing the number of colors will be described with reference to the flow chart shown in FIG. 22. This process is another example of the omnidirectional-image image-data creating process in step S12 shown in FIG. 5 (i.e., the process shown in FIG. 7). Thus, viewpoint information from the user terminal 2 has been output from the communication unit 71 of the server 3 to the viewpoint determining unit 64.

In step S61, the encoder 65 sets a predetermined number of colors C1 to be used to be equal to the number of colors C. In step S62, the encoder 65 receives eight-directional image data from the cameras 5-1 to 5-8 of the image capturing device 4.

In step S63, based on the viewpoint information from the viewpoint determining unit 64, the encoder 65 selects an image to be encoded and designates the selected image as X. In step 64, the encoder 65 designates the adjacent image to the left of X as Y. In the present case, since the current viewpoint information is “N”, X is the “N” image and Y is the “NW” image.

In step S65, the encoder 65 determines whether image data of X has already been encoded. When it is determined that image data of X has not yet been encoded, in step S66, image data of X is encoded with the number of colors C. That is, image data for “N” is encoded with the predetermined number of colors C1 (the greatest number of colors). In step S67, the encoder 65 moves X to the adjacent right image. In the present case, X is the “NE” image.

In step S68, the encoder 65 sets one-half the number of the current number of colors (in the present case, the number of colors C1) as a new number of colors C. In step S69, the encoder 65 determines whether image data of Y has already been encoded. In step S69, when it is determined that image data of Y has not yet been encoded, in step S70, the encoder 65 encodes image data of Y with the number of colors C. That is, image data for “NW” is encoded with one-half the number of colors C1. In step S71, the encoder 65 moves Y to the adjacent left image. In the present case, X is the “W” image.

The process returns to step S65, and the encoder 65 repeats processing thereafter. In the same manner, image data for “NE” is encoded with one-half the number of colors C1, image data for “W” and “E” is encoded with one-fourth the number of colors C1, image data for “SW” and “SE” is encoded with one-eighth the number of colors C1, and image data for “S” is encoded with one-sixteenth the number of colors C1. When it is determined that image data of X has already been encoded in step S65 or image data of Y has already been encoded in step S69, image data for all directions have been encoded, and thus the omnidirectional-image image-data creating process ends.

As described above, as compared to image data for a direction closer to the current viewpoint direction, image data for a direction farther from the current viewpoint direction is encoded with a less number of colors. Thus, the amount of image-data information to be transmitted can be reduced. In the above configuration, the amount of image-data information may be reduced in proportion to a distance from a viewpoint so as to reduce the number of colors in an image, to reduce the size of the image, or to change a quantization parameter.

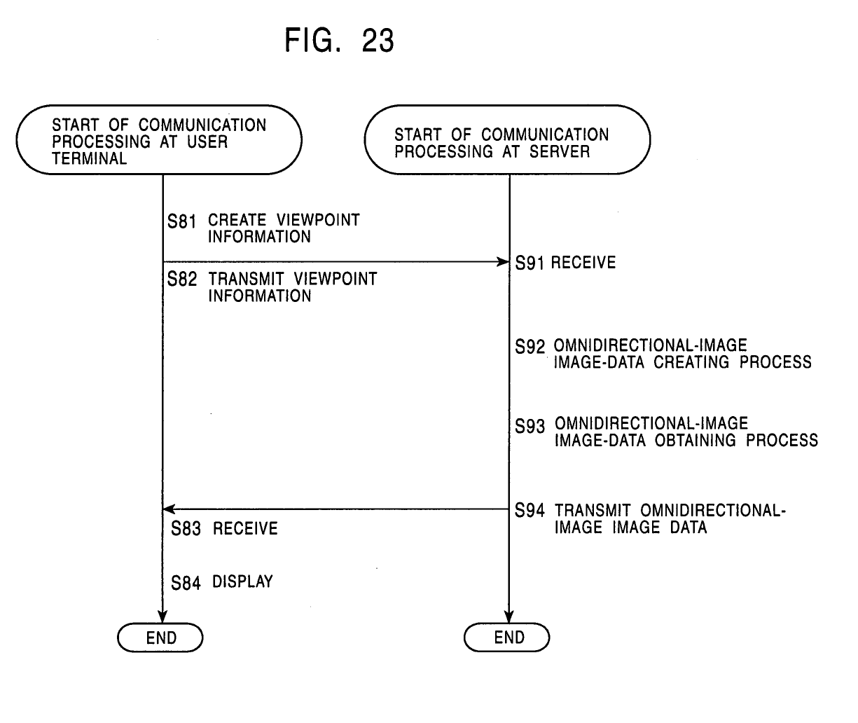

Next, communication processing when encoded image data is transmitted after being temporarily stored in the storage unit 70 will be described with reference to the flow chart shown in FIG. 23. First, the user operates the input unit 28 of the user terminal 2 to input a current viewpoint (“N” in the present case). In response to the input, in step S81, the viewpoint designating unit 24 creates viewpoint information. In step S82, the communication unit 31 transmits the viewpoint information, created by the viewpoint designating unit 24, to the server 3 over the network 1.

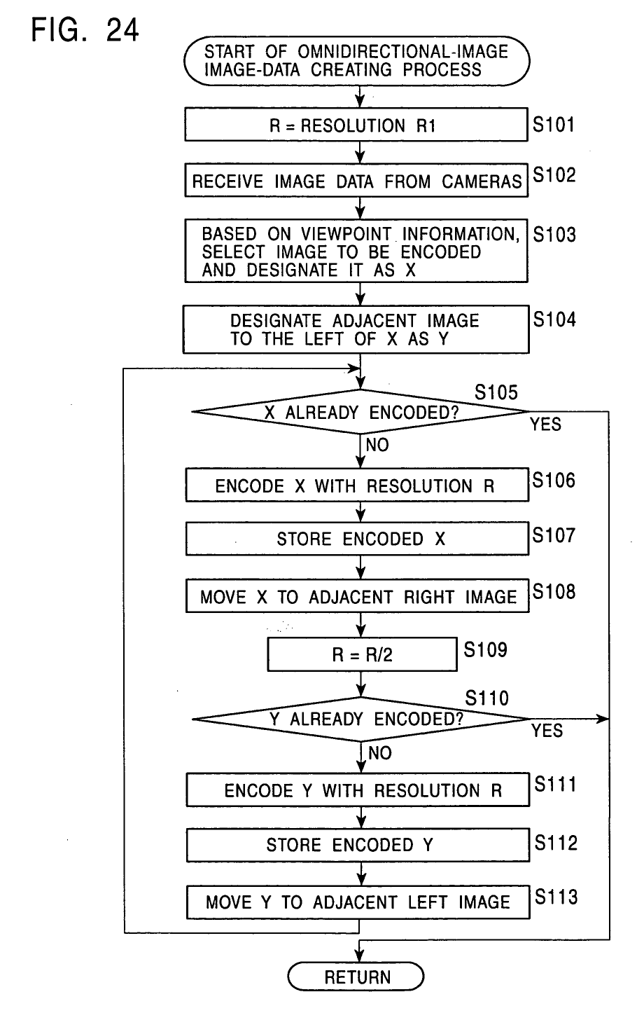

In step S91, the communication unit 71 of the server 3 receives the viewpoint information from the user terminal 2 and outputs the received viewpoint information to the viewpoint determining unit 64. In step S92, the encoder 65 executes an omnidirectional-image image-data creating process. This omnidirectional-image image-data creating process will now be described with reference to the flow chart shown in FIG. 24. Processing in steps S101 to S106, S108 to S111, and S113 is analogous to the processing in steps S31 to S41 shown in FIG. 7, the description thereof will be omitted to avoid repetition.

Thus, a resolution R is set, and image data for eight directions is obtained from the cameras 5-1 to 5-8. Then, an image X and an image Y are obtained based on the viewpoint information from the viewpoint determining unit 64. In step S105, when it is determined that image data of X has not yet been encoded, in step S106, the encoder 65 encodes image data of X with the corresponding resolution R. Thus, in step S107, the encoder 65 stores the encoded image data of X in the storage unit 70.

Similarly, in step S110, when it is determined that image data of Y has not yet been encoded, in step S111, the encoder 65 encodes image data of Y with a corresponding resolution R. Thus, in step S112, the encoder 65 stores the encoded image data of Y in the storage unit 70.

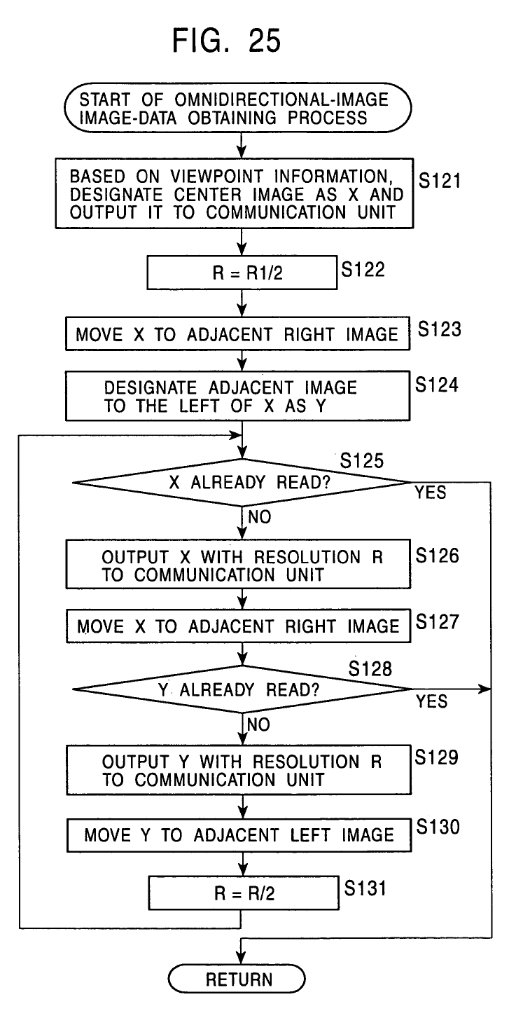

In the above-described processing, individual pieces of image data of omnidirectional-images are encoded with corresponding resolutions and the resulting data is temporarily stored in the storage unit 70. Next, in step S93, the CPU 61 executes an omnidirectional-image image-data obtaining process. This omnidirectional-image image-data obtaining process will now be described with reference to the flow chart shown in FIG. 25.

In step S121, based on the viewpoint information from the viewpoint determining unit 64, the CPU 61 designates a center “N” image as X, reads “N” image data encoded with the set resolution R1 (the highest resolution) from the storage unit 70, and outputs the read image data to the communication unit 71.

In step S122, the CPU 61 reduces the current resolution (the resolution R1 in the present case) by one half and designates the one-half resolution as a new resolution R. In step S123, the CPU 61 moves X to the adjacent right image. In step S124, the CPU 61 designates the adjacent image to the left of X as Y.

In step S125, the CPU 61 determines whether image data of X has already been read from the storage unit 70. When it is determined that image data of X has not yet been read from the storage unit 70, in step S126, the CPU 61 reads image data of X with the resolution R from the storage unit 70 and outputs the read image data to the communication unit 71. That is, in the present case, “NE” image data with one-half the resolution R1 is read from the storage unit 70.

In step S127, the CPU 61 moves X to the adjacent right image, and, in step S128, the CPU 61 determines whether image data of Y has already been read from the storage unit 70. In step S128, when it is determined that image data of Y has not yet been read from the storage unit 70, in step S129, the CPU 61 reads image data of Y with the resolution R from the storage unit 70 and outputs the read image data to the communication unit 71. That is, in the present case, “NW” image data with one-half the resolution R1 is read from the storage unit 70.

In step S130, the CPU 61 moves Y to the adjacent left image. In step S131, the CPU 61 converts the resolution R (one-half the resolution R1 in the present case) into one-half the resolution R (i.e., one-forth the resolution R1) and designates the resulting resolution as a resolution R, and then returns to step S125 and repeats the processing thereafter.

When it is determined that image data of X has already been read in step S125 or image data of Y has already been read in step S128, all image data has been read, and thus the process ends.

For example, when the resolution for the current viewpoint is 1, from the processing described above, “N” image data with the resolution 1 is output to the communication unit 71, one-half-resolution image data for “NW” and “NE” which are adjacent to the left and right of “N” is output to the communication unit 71, and one-fourth-resolution image data for “W” adjacent to the left of “NW” and for “E” adjacent to the right of “NE” is output to the communication unit 71. One-eighth-resolution image data for “SW” adjacent to the left of “W” and for “SE” adjacent to the right of “E” is output to the communication unit 71, and one-sixteenth-resolution image data for “S” adjacent to the left of “SW” (i.e., in the diametrically opposite direction to “N”) is output.

In step S94 in FIG. 23, the communication unit 71 transmits the omnidirectional-image image data to the user terminal 2 over the network 1. In step S83, the communication unit 31 of the user terminal 2 receives the omnidirectional-image image data and supplies the received data to the decoder 25. In step S84, based on the viewpoint information from the viewpoint designating unit 24, the decoder 25 decodes, out of the omnidirectional-image image data, image data for a direction corresponding to the current viewpoint, and supplies the decoded image data to the output unit 29. A decoded image is displayed on a display which is included in the output unit 29.

As described above, after image data is encoded with different resolutions with respect to individual images from the cameras and is temporarily stored, the data is read and transmitted. Thus, for example, it is possible to perform such a real-time distribution reply that the server 3 side (a host side) can recognize in what manner the user enjoys omnidirectional images. In this case, the communication unit 71 transmits image data all together to the user terminal 2 after obtaining all the image data based on the viewpoint information. However, every time the CPU 61 outputs each-directional image data, the communication unit 71 may transmit the image data to the user terminal 2 over the network 1. In such a case, since image data is read and transmitted in decreasing order of resolution, not only can the amount of image-data information to be transmitted be reduced, but also the receiving side can perform display more promptly.

In step S92 shown in FIG. 23 in which encoded image data for omnidirectional-images is generated for each-directional image data and is stored, when the image data is encoded in the JPEG 2000 format described with reference to FIG. 13, for example, eight-directional images with different resolutions can be connected and combined into one image, as shown in FIG. 8. As a result, the cost for data management at the storage unit 70 can be reduced. In addition, for example, when a plurality of pieces of image data are encoded with the same compression data, such as a case in which a viewpoint exists between “N” and “NE”, connected images in adjacent directions allows one file of the connected portions to be encoded. As a result, the processing complexity can be reduced.

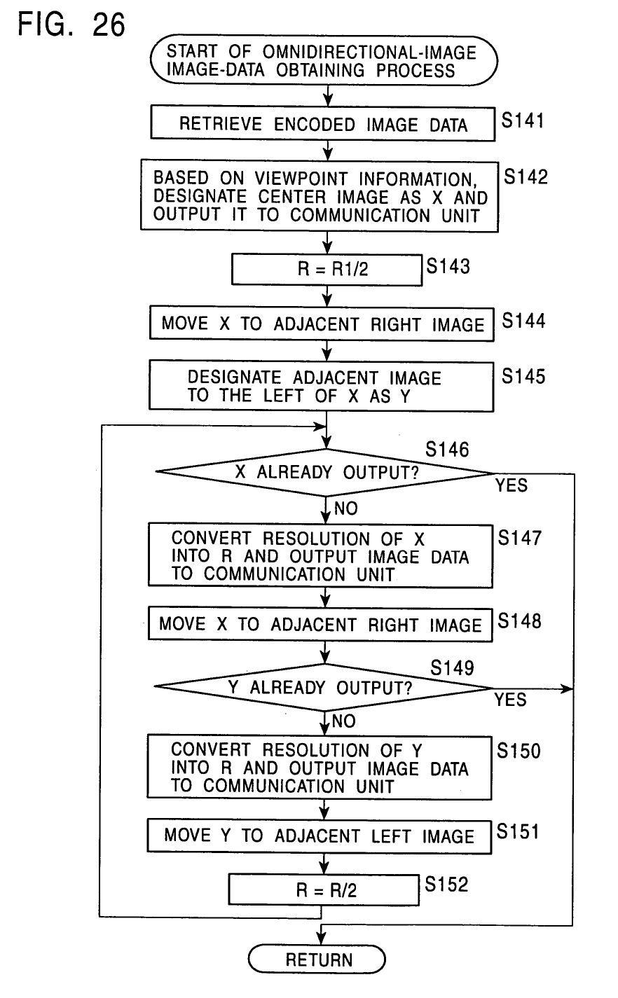

Further, another example of the omnidirectional-image image-data obtaining process will be described with reference to the flow chart shown in FIG. 26. This process is another example of the omnidirectional-image image-data obtaining process in step S93 shown in FIG. 23 (i.e., the process in FIG. 25). It is assumed that, in the present case, in the process in step S92 shown in FIG. 23, all the omnidirectional-image image data is encoded with only the set resolution R1 (the highest resolution) by the encoder 65 and the encoded image data is temporarily stored in the storage unit 70.

In step S141, the CPU 61 retrieves the encoded omnidirectional (eight directional) image data from the storage unit 70. In step S142, the CPU 61 designates the center “N” image as X based on the viewpoint information from the viewpoint determining unit 64, and outputs image data of X to the communication unit 71 with an unchanged resolution R1.

In step S143, the CPU 61 reduces the current resolution (the resolution R1 in the present case) by one half and sets the one-half resolution as a new resolution R. In step S144, the CPU 61 moves X to the adjacent right image. In step S145, the CPU 61 designates the adjacent image to the left of X as Y.

In step S146, the CPU 61 determines whether image data of X has already been output to the communication unit 71. When it is determined that image data of X has not yet been output to the communication unit 71, in step S147, the CPU 61 converts the resolution of image data of X into the resolution R and outputs the resulting image data of X to the communication unit 71. Thus, in the present case, the resolution of “NE” image data is converted into one-half the resolution R1 and the resulting image data is output to the communication unit 71.

In step S148, the CPU 61 moves X to the adjacent right image, and, in step S149, the CPU 61 determines whether image data of Y has already been output to the communication unit 71. In step S149, when it is determined that image data of Y has not yet been output to the communication unit 71, in step S150, the CPU 61 converts the resolution of image data of Y into the resolution R and outputs the resulting image data of Y to the communication unit 71. That is, in the present case, the resolution of “NW” image data is converted into one-half the resolution R1 and the resulting image data is output to the communication unit 71.

In step S151, the CPU 61 moves Y to the adjacent left image. In step S152, the CPU 61 converts the resolution R (one-half the resolution R1 in the present case) into one-half the resolution R (one-forth the resolution R1) and designates the resulting resolution as a resolution R, and then returns to step S146 and repeats the processing thereafter.

When it is determined that image data of X has already been output to the communication unit 71 in step S146 or when it is determined that image data of Y has already been output to the communication unit 71 in step S149, all image data has been output to the communication unit 71, and thus the process ends.

As described above, even when image data that is encoded with a set high resolution with respect to images from the cameras is temporarily stored, is read, is subjected to resolution conversion based on viewpoint information, and is then transmitted, it is possible to reduce the amount of image-data information to be transmitted.

In the above, the description has been given of a case in which, after a captured image is encoded with a corresponding resolution or set resolution, is temporarily stored, and is read, the image data is transmitted (i.e., the transmission is performed while storing a captured image). The transmission, however, may be performed after obtaining, in step S93 in FIG. 23, images that are encoded with various resolutions by the encoder 65 and that are pre-stored in the storage unit 70 of the server 3.

That is, in such case, in FIG. 23, the process in step S92 is not executed (since it is executed prior to the omnidirectional-image data communication process in FIG. 23). In the omnidirectional-image image-data obtaining process in step S93 (FIG. 25), images are captured by the cameras 5-1 to 5-8 of the image capturing device 4 and are encoded with various resolutions. Of pre-stored image data, image data having a resolution corresponding to the viewpoint information is read and transmitted. The resolutions in this case may be any resolutions that can be provided by the omnidirectional-image providing system so as to be used in the obtaining process in FIG. 25, or the resolutions maybe set to a high resolution to be used in the obtaining process in FIG. 26.

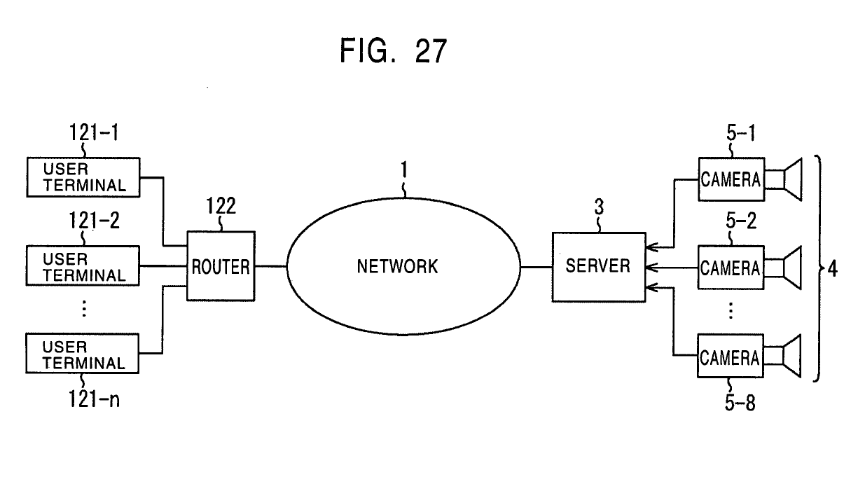

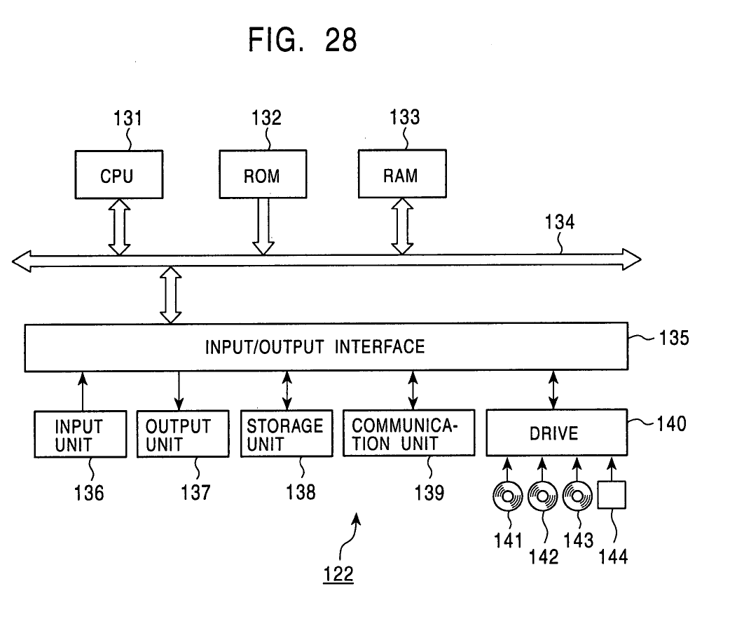

Next, another exemplary configuration of the omnidirectional-image providing system according to the present invention will be described with reference to FIG. 27. In FIG. 27, sections or units corresponding to those in FIG. 1 are denoted with the same reference numerals, and the descriptions thereof will be omitted to avoid repetition.

In this example, n user terminals 121-1, 121-2, . . . , and 121-n (hereinafter simply referred to as “user terminals 121” when there is no need to distinguish them individually) are connected to the network 1 via a router 122. The router 122 is a multicast router. Based on the viewpoint information from the user terminals 121, the router 122 retrieves, out of the omnidirectional-image image data transmitted from the server 3, image data to be transmitted to the individual user terminals 121, and executes processing for transmitting the retrieved image data to the corresponding user terminals 121. Since the user terminals 121 have essentially the same configuration as the user terminal 1, the description thereof will be omitted to avoid repetition.

FIG. 28 shows an exemplary configuration of the router 122. In FIG. 28, a CPU 131 to a RAM 133 and a bus 134 to a semiconductor memory 144 essentially have the same functions as the CPU 21 to the RAM 23 and the bus 26 to the semiconductor memory 44 of the user terminal 2 shown in FIG. 3. Thus, the descriptions thereof will be omitted.

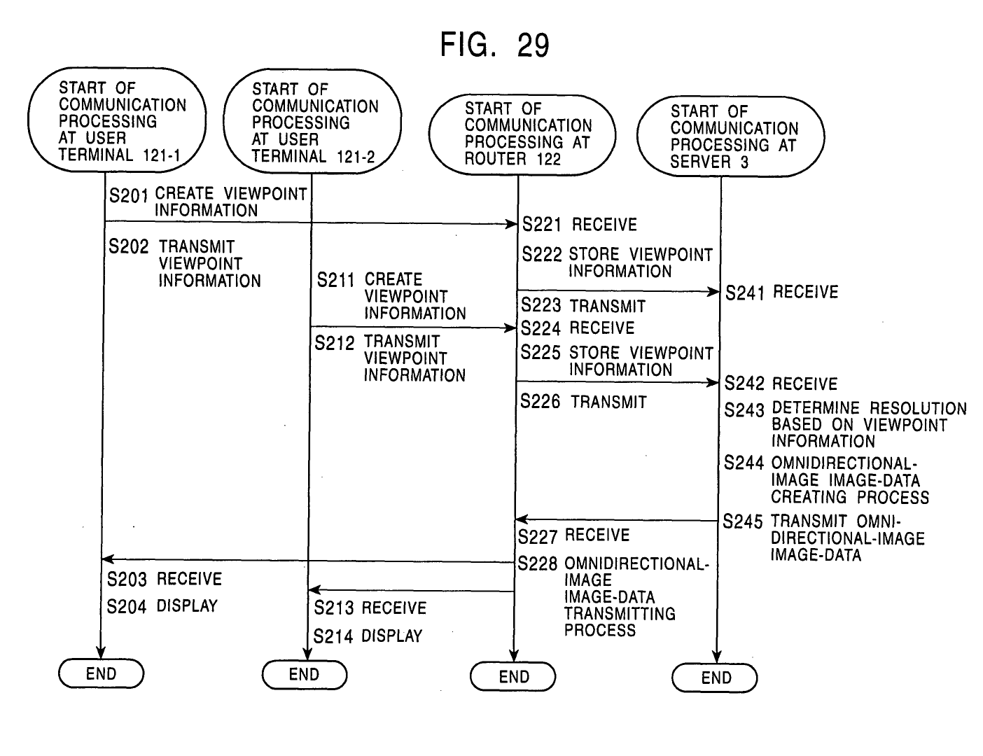

Next, communication processing of the omnidirectional-image providing system shown in FIG. 27 will be described with reference to the flow chart shown in FIG. 29. For convenience of illustration, while two user terminals 121-1 and 121-2 are illustrated in FIG. 29, the number of user terminals is n (n>0) in practice.

First, a user operates the input unit 28 of the user terminal 121-1 to input a current viewpoint (“N” in the present case). In response to the input, in step S201, the viewpoint designating unit 24 creates viewpoint information. In step S202, the communication unit 31 transmits the viewpoint information, created by the viewpoint designating unit 24, to the server 3 via the router 122.

In step S221, the CPU 131 of the router 122 uses the communication unit 139 to receive the viewpoint information “N” from the user terminal 121-1. In step S222, the CPU 131 stores the viewpoint information “N” in a viewpoint-information table included in the storage unit 138 or the like. In step S223, the CPU 131 uses the communication unit 139 to transmit the viewpoint information “N” to the server 3 over the network 1.

Similarly, a user operates the input unit 28 of the user terminal 121-2 to input a current viewpoint (“NE” in the present case). In response to the input, in step S211, the viewpoint designating unit 24 creates viewpoint information. In step S212, the communication unit 31 transmits the viewpoint information, created by the viewpoint designating unit 24, to the server 3 via the router 122.

In step S224, the CPU 131 of the router 122 uses the communication unit 139 to receive the viewpoint information “NE” from the user terminal 121-2. In step S225, the CPU 131 stores the viewpoint information “NE” in the viewpoint-information table included in the storage unit 138 or the like. In step S226, the CPU 131 uses the communication unit 139 to transmit the viewpoint information “NE” to the server 3 over the network 1.

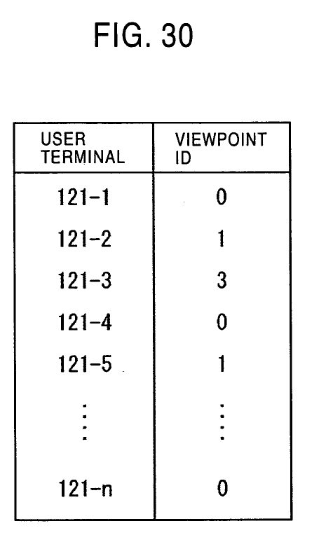

The viewpoint-information table stored in the router 122 will now be described with reference to FIG. 30. In this viewpoint-information table, the viewpoint IDs described with reference to FIG. 10 are associated with the individual user terminals 121.

In the example of FIG. 30, since the viewpoint information “N” (i.e., viewpoint ID “0”) is transmitted from the user terminal 121-1, viewpoint ID “0” is associated with the user terminal 121-1. Also, since the viewpoint information “NE” (i.e., viewpoint ID “1”) is transmitted from the user terminal 121-2, viewpoint ID “1” is associated with the user terminal 121-2. Similarly, viewpoint ID “3” is associated with the user terminal 121-3, viewpoint ID “0” is associated with the user terminal 121-4, viewpoint ID “1” is associated with the user terminal 121-5, . . . , and viewpoint ID “0” is associated with the user terminal 121-n.

As described above, these viewpoint IDs are shared by the user terminals 121, the router 122, and the server 3. Meanwhile, in step S241, the communication unit 71 of the server 3 receives the viewpoint information “N” from the user terminal 121-1 via the router 122 and outputs the viewpoint information “N” to the viewpoint determining unit 64. In step S242, the communication unit 71 receives the viewpoint information “NE” from the user terminal 121-2 via the router 122 and outputs the viewpoint information “NE” to the viewpoint determining unit 64.

In step S243, the viewpoint determining unit 64 determines a resolution for an image in each direction, based on the viewpoint information obtained from all the user terminals 121. In the present case, with respect to an image in each direction, the viewpoint determining unit 64 collects resolutions requested by all the user terminals 121 and designates the highest resolution thereof as a resolution for the image.

For example, when the viewpoint determining unit 64 obtains the viewpoint information (FIG. 30) from the user terminals 121-1 to 121-5, with respect to an “N” (viewpoint ID “0”) image, a set resolution R1 is requested by the user terminal 121-1 having viewpoint ID “0”, one-half the resolution R1 is requested by the user terminal 121-2 having viewpoint ID “1”, one-eighth the resolution R1 is requested by the user terminal 121-3 having viewpoint ID “3”, the resolution R1 is requested by the user terminal 121-4 having viewpoint ID “0”, and one-half the resolution R1 is requested by the user terminal 121-5 having viewpoint ID “1”. Thus, the resolution for the “N” image is set to be the resolution R1, which is the highest resolution of those resolutions.

Similarly, with respect to an “E” (viewpoint ID “2”) image, one-fourth the resolution R1 is requested by the user terminal 121-1 having viewpoint ID “0”, one-half the resolution R1 is requested by the user terminal 121-2 having viewpoint ID “1”, one-half the resolution R1 is requested by the user terminal 121-3 having viewpoint ID “3”, one-fourth the resolution R1 is requested by the user terminal 121-4 having viewpoint ID “0”, and one-half the resolution R1 is requested by the user terminal 121-5 having viewpoint ID “1”. Thus, the resolution for the “N” image is set to be one-half the resolution R1, which is the highest resolution of those resolutions.

The computational processing in step S243 is an effective method when the number of user terminals 121 is small. When the number of user terminals 121 is large, all images may be transmitted with the set resolution R1 in order to reduce the computational load.

As described above, the resolution for an image in each direction is determined. Thus, based on the resolution, in step S244, the encoder 65 encodes eight-directional image data supplied from the cameras 5-1 to 5-8 of the image capturing device 4.

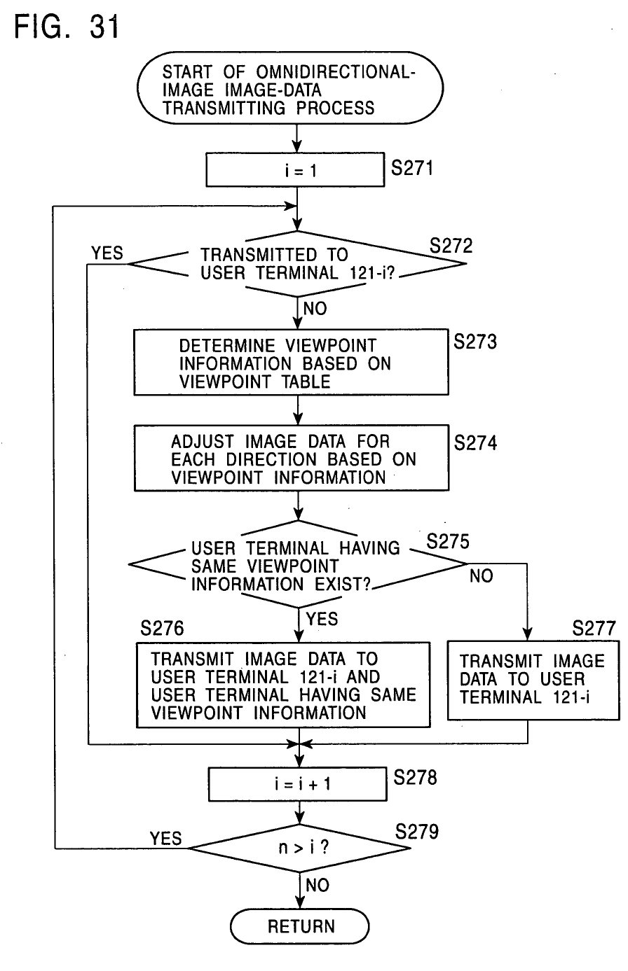

In step S245, the communication unit 71 transmits the omnidirectional-image image data encoded by the encoder 65 to the user terminals 121 through the network 1 and the router 122. In response to the transmission, in step S227, the CPU 131 of the router 122 receives the omnidirectional-image image data via the communication unit 139, and, in step S228, executes an image-data transmitting process. This image-data transmitting process will now be described with reference to the flow chart shown in FIG. 31. In the present case, the number of user terminals 121 is n (n>0).

In step S271, the CPU 131 sets i to be 1. In step S272, the CPU 131 determines whether image data has been transmitted to the user terminal 121-i (i=1 in the present case). In step S272, when it is determined that image data has not yet been transmitted to the user terminal 121-1, in step S273, the CPU 131 determines the viewpoint information of the user terminal 121-1 based on the viewpoint table described with reference to FIG. 30.

In step S274, the CPU 131 adjusts the resolution of the omnidirectional-image image data to a suitable resolution based on the viewpoint information “N” of the user terminal 121-1. That is, when the resolution of image data received and the resolution of image data to be transmitted are the same, the resolution is not changed. Also, when the resolution of requested image data is lower than the resolution of received image data, the resolution is converted into the resolution of the requested image data.

For example, with respect to the user terminal 121-1, “N” image data is received with the resolution R1, thus, the resolution R1 is not changed; “NE” image data is received with the resolution R1, thus, the resolution is converted into one-half the resolution R1; and “E” image data is received with one-half the resolution R1, thus, the resolution is converted into one-half the resolution (i.e., one-fourth the resolution R1).

In step S275, the CPU 131 determines whether there is a user terminal having the same viewpoint information as the user terminal 121-1 based on the viewpoint table. When it is determined that there is a user terminal having the same viewpoint information (e.g., the user terminal 121-4 and the user terminal 121-n), in step S276, the omnidirectional-image image data adjusted in step S274 is transmitted to the user terminals 121-1, 121-4, and 121-n.

In step S275, when it is determined that there is no user terminal having the same viewpoint information as the user terminal 121-1, based on the viewpoint table, in step S277, the adjusted omnidirectional-image image data is transmitted to only the user terminal 121-1. In step S272, when it is determined that image data has already been transmitted to the user terminal 121-i, the processing in steps S273 to S277 is skipped.

In step S278, the CPU 131 increments i by 1 (i=2 in the present case), and in step S279, the CPU 131 determines whether i is smaller than n. In step S279, when it is determined that i is smaller than n, the process returns to step S272, and the processing thereafter is repeated. In step S279, when it is determined that i is larger than n or is equal to n, the transmitting process ends. From the above processing, omnidirectional-image image data based on the viewpoint information “N” is transmitted to the user terminal 121-1 and omnidirectional-image image data based on the viewpoint information “NE” is transmitted to the user terminal 121-2.

Referring back to FIG. 29, in response to the above processing at the router 122, in step S203, the communication unit 31 of the user terminal 121-1 receives the omnidirectional-image image data and supplies the image data to the decoder 25. In step S204, based on the viewpoint information from the viewpoint designating unit 24, the decoder 25 decodes, out of the omnidirectional-image image data, image data for a direction corresponding to the current viewpoint, and supplies the decoded image to the output unit 29. A decoded image is displayed on the display included in the output unit 29.

Similarly, in step S213, the communication unit 31 of the user terminal 121-2 receives the omnidirectional-image image data and supplies the received image data to the decoder 25. In step S214, based on the viewpoint information from the viewpoint designating unit 24, the decoder 25 decodes, out of the omnidirectional-image image data, image data in a direction corresponding to the current viewpoint, and supplies a decoded image to the output unit 29. The decoded image is displayed on the display included in the output unit 29.

As described above, although the individual user terminals 121 have differences in viewpoints, they can receive data whose image source is the same. As a result, a load on the server 3 is reduced and the amount of data over the network 1 is also reduced. Further, in the above description, although the image data that is encoded by the encoder 65 of the server 3 is immediately transmitted to the network 1 via the communication unit 71, the encoded image data may be temporarily stored in the storage unit 70 in this case as well.

In addition, in the above, since the image data is encoded in the JPEG 2000 format, high-resolution image data can be easily converted into low-resolution image data (i.e., low-resolution image data can be easily extracted from high-resolution image data). Thus, there is no need to perform decoding for conversion, so that a load on the router 122 can be reduced.

Additionally, when a sufficient band is available between the router 122 and the user terminals 121, the image data may be transmitted with a higher resolution than a resolution requested by the user terminals 121. In such a case, each user terminal 121 will reduce the resolution, depending on a required memory capacity.

In the above, although the description has been given of an example in which the resolutions of images are exponentially changed by ½, ¼, ⅛, and 1/16, it is not particularly limited. For example, the resolutions may be linearly changed by ⅘, ⅗, ⅖ and ⅕. Alternatively, for omnidirectional images when the viewer is very likely to suddenly view behind, the resolutions may be changed such that they increase after a decrease, by ½, ¼, 1/2 and 1. Different resolutions may also be used for individual images captured by the cameras 5-1 to 5-8.

While eight cameras are provided for one server in the above-described configuration, one server may be provided for each camera. In such a case, viewpoint information from a user terminal is transmitted to the corresponding server, and only image data for the direction of the camera corresponding to the server may be encoded. The present invention can be applied to not only a case of providing omnidirectional images but also a case of providing onmi-view images.

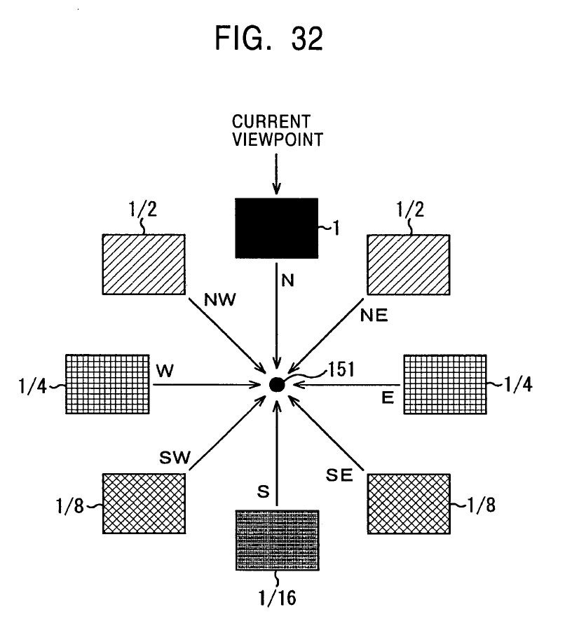

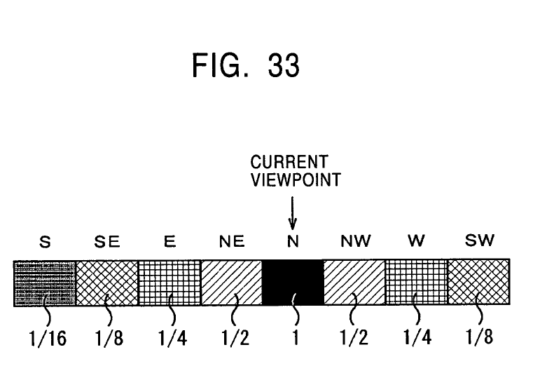

As shown in FIG. 32, “omni-view images” can be obtained by capturing images of an arbitrary object 151 from all 360-degree directions. In the example of FIG. 32, eight cameras capture images in eight directions, namely, “N” in the upper center direction, “NE”, “El”, “SE”, “S”, “SW”, “W”, and “NW” in a clockwise direction. From these images, connecting and combining the images in the adjacent directions can provide one file of images, as shown in FIG. 33, in which “S”, “SE”, “E”, “NE”, “N”, “NW”, “W”, and “SW” images are sequentially connected from the left. In this arrangement, for example, when the current viewpoint represents “N”, the movement of the viewpoint to the right means the movement to an “NW” image, and conversely, the movement of the viewpoint to the left means the movement to an “NE” image. This arrangement is, therefore, analogous to an arrangement in which the left and the right of the series of the “omnidirectional images” described with reference to FIG. 8 are reversed, and is essentially the same as the example of the above-described omnidirectional images except that the configuration of the capturing device 4 described with reference to FIG. 2 is changed. Herein, “omni-view images” are therefore included in the “omnidirectional images”.

As described above, based on viewpoint information, image data is encoded with a resolution, color, and size corresponding to the viewpoint information. Thus, when a user views “omnidirectional images” (including “omni-view images”), reaction time in response to a user's viewpoint movement can be reduced. Further, the amount of data flowing into a communication path over a network can be reduced.

In addition, when a great number of users view “omnidirectional images” (including “omni-view images”), images can be smoothly provided. The above-described configuration can achieve an improved omnidirectional-image providing system that allows a user to view “omnidirectional images” (including “omni-view images”) while smoothly moving the viewpoint.

The series of processes described above can be implemented with hardware and also can be executed with software. When the series of processes is executed with software, a computer that is implemented with dedicated hardware into which a program that realizes such software is incorporated may be used, or alternatively, such software is installed on a general-purpose personal computer, which can execute various functions by installing various programs, from a program-storing medium.

Examples of the program-storing medium for storing a program that is installed on a computer and that is executable by the computer include, as shown in FIGS. 3, 4, and 28, magnetic disks 41, 81, and 141, (including flexible disks), optical discs 42, 82, and 142 (including CD-ROMs (Compact Disc Read Only Memories) and DVDs (Digital Versatile Discs)), magnetic optical discs 43, 83, and 143 (including MDs (Mini Discs) (trademark)), and packaged media such as semiconductor memories 44, 84, and 144, ROMs 22, 62, and 132 in which the program is temporarily or permanently stored, and storage units 30, 70, and 138.

Herein, steps for writing the program onto a recording medium may or may not be performed sequentially according to the order described above, and also includes processing that is performed in parallel or independently. Herein, the term “system” represents the entirety of the plurality of apparatuses.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. An information providing system, comprising:
an information processing apparatus; and
an information supplying apparatus for supplying image data of omnidirectional images to the information processing apparatus over a network,
wherein the information supplying apparatus obtains viewpoint information set by the information processing apparatus; encodes the image data of the omnidirectional images, based on the obtained viewpoint information, such that image data of an image in a second direction has a lower resolution than image data of an image in a first direction corresponding to the viewpoint information, the first direction and the second direction being different from each other; and transmits the encoded image data of the omnidirectional images to the information processing apparatus, and
wherein the information processing apparatus decodes, out of the received image data of the omnidirectional images, image data corresponding to the viewpoint information, and outputs the decoded image data.

2. An information providing method for an information providing system in which an information supplying apparatus supplies image data of omnidirectional images to an information processing apparatus over a network, the information providing method comprising:
an information supplying method; and
an information processing method,
wherein the information supplying method includes the steps of obtaining viewpoint information set by the information processing apparatus; encoding the image data of the omnidirectional images, based on the obtained viewpoint information, such that image data of an image in a second direction has a lower resolution than image data of an image in a first direction corresponding to the viewpoint information, the first direction and the second direction being different from each other; and transmitting the encoded image data of the omnidirectional images to the information processing apparatus, and
wherein the information processing method includes the steps of decoding, out of the received image data of the omnidirectional images, image data corresponding to the viewpoint information, and outputting the decoded image data.

3. An information supplying apparatus that supplies image data of omnidirectional images to at least one information processing apparatus over a network, the information supplying apparatus comprising:
receiving means for receiving viewpoint information from the at least one information processing apparatus;
encoding means for encoding the image data of the omnidirectional images, based on the viewpoint information received by the receiving means, such that image data of images in a second direction has a lower resolution than image data of an image in a first direction corresponding to the viewpoint information, the first direction and the second direction being different from each other; and
transmitting means for transmitting the image data of the omnidirectional images which is encoded by the encoding means to the at least one information processing apparatus.

4. An information supplying apparatus according to claim 3, wherein the encoding means encodes the image data in a joint photographic experts group 2000 format.

5. An information supplying apparatus according to claim 3, wherein the encoding means encodes the image data of the omnidirectional images, so that, of the images in the second direction, an image in a direction farther from the first direction has an even lower resolution.

6. An information supplying apparatus according to claim 3, wherein the resolution is set by the number of pixels or the number of colors.

7. An information supplying apparatus according to claim 3, further comprising storing means for storing the image data of the omnidirectional images which is encoded by the encoding means.

8. An information supplying apparatus according to claim 7, further comprising combining means for combining the image data of the omnidirectional images which is encoded by the encoding means into one file of image data, wherein the storing means stores the one file of image data combined by the combining means.

9. An information supplying apparatus according to claim 7, further comprising converting means for converting, based on the viewpoint information, the resolution of the image data of the images in the second direction, the image data being stored by the storing means, into a lower resolution, wherein the transmitting means transmits the image data of the omnidirectional images which is converted by the converting means.

10. An information supplying apparatus according to claim 3, further comprising selecting means for selecting, based on the viewpoint information received by the receiving means from the information processing apparatuses, a highest resolution of the resolutions of the image data of the images in the second direction, the image data being transmitted to the information processing apparatuses, wherein the transmitting means transmits image data of the omnidirectional images which has a resolution lower than or equal to the resolution selected by the selecting means.

11. An information supplying method for an information supplying apparatus that supplies image data of omnidirectional images to an information processing apparatus over a network, the information supplying method comprising:
a receiving step of receiving viewpoint information from the information processing apparatus;
an encoding step of encoding the image data of the omnidirectional images, based on the viewpoint information received in the receiving step, such that image data of an image in a second direction has a lower resolution than image data of an image in a first direction corresponding to the viewpoint information, the first direction and the second direction being different from each other; and
a transmitting step of transmitting the image data of the omnidirectional images which is encoded in the encoding step to the information processing apparatus.

12. A recording medium in which a program for an information supplying apparatus that supplies image data of omnidirectional images to an information processing apparatus over a network is recorded, the program being readable by a computer, the program comprising:
a receiving step of receiving viewpoint information from the information processing apparatus;
an encoding step of encoding the image data of the omnidirectional images, based on the viewpoint information received in the receiving step, such that image data of an image in a second direction has a lower resolution than image data of an image in a first direction corresponding to the viewpoint information, the first direction and the second direction being different from each other; and
a transmitting step of transmitting the image data of the omnidirectional images which is encoded in the encoding step to the information processing apparatus.

13. A program executed by a computer for controlling an information supplying apparatus that supplies image data of omnidirectional images to an information processing apparatus over a network, the program comprising:
a receiving step of receiving viewpoint information from the information processing apparatus;
an encoding step of encoding the image data of the omnidirectional images, based on the viewpoint information received in the receiving step, such that image data of an image in a second direction has a lower resolution than image data of an image in a first direction corresponding to the viewpoint information, the first direction and the second direction being different from each other; and
a transmitting step of transmitting the image data of the omnidirectional images which is encoded in the encoding step to the information processing apparatus.
